(19) United States
(12) Patent Application Publication
(10) Pub. No.: US 2024/0304354 A1
(43) Pub. Date: Sep. 12, 2024

(54) PARTICLE TRAP SYSTEM

(71) Applicants: HUAWEI TECHNOLOGIES CO., LTD., Shenzhen (CN); University of Science and Technology of China, Hefei (CN)

(72) Inventors: Mengxiang Zhang, Hefei (CN); Chao Yang, Shenzhen (CN); Yiheng Lin, Hefei (CN); Jiangfeng Du, Hefei (CN)

(21) Appl. No.: 18/666,581

(22) Filed: May 16, 2024

Related U.S. Application Data
(63) Continuation of application No. PCT/CN2022/107608, filed on Jul. 25, 2022.

(30) Foreign Application Priority Data
Nov. 16, 2021 (CN) 202111356743.9

(51) Int. Cl. G21K 1/00; G02B 17/02; G02B 27/28

(52) U.S. Cl. CPC G21K 1/006; G02B 17/023; G02B 27/286

(57) ABSTRACT

A particle trap system is provided, to resolve a problem of complex particle addressing in a conventional technology, and can be used in fields such as quantum computing. The particle trap system may include a trapping module, a first optical splitting module, and a first relative delay module. The trapping module is configured to trap at least two particles. The first optical splitting module is configured to split a received light beam into a first light beam and a second light beam. The first relative delay module is configured to adjust a delay amount for the first light beam and the second light beam to reach a first target particle, where an adjusted first light beam and an adjusted second light beam overlap at the first target particle, and the first target particle is at least one particle in the trapping module.

### CROSS-REFERENCE TO RELATED APPLICATIONS

This application is a continuation of International Application No. PCT/CN2022/107608, filed on Jul. 25, 2022, which claims priority to Chinese Patent Application No. 202111356743.9, filed on Nov. 16, 2021. The disclosures of the aforementioned applications are hereby incorporated by reference in their entireties.

### TECHNICAL FIELD

This application relates to the field of quantum computing technologies, and in particular, to a particle trap system.

### BACKGROUND

With the development of information technologies, quantum computing has attracted more and more attention. A core of quantum computing is to implement universal quantum computing via a quantum system. A basic principle of quantum computing is to encode information by using a quantum bit (such as an ion). A state (or referred to as a quantum state) of a single quantum bit has two classical states of 0 and 1, and a superposition state of 0 and 1. As shown in FIG. 1a, a quantum bit may be in a state of 0 at a half probability, and in a state of 1 at a half probability. n quantum bits may be in a superposition state of 2″ quantum states at the same time, thereby improving a computing speed.

In a physical implementation of quantum computing, current mainstream schemes are an ion trap system and a superconductive system. The ion trap system mainly includes ions and an electrode structure for trapping ions. The ions may be trapped in space in a specific structure by applying a specific electromagnetic field to the electrode structure and combining a coulomb action between the ions. The trapped ions are addressed (that is, the trapped ions are aligned with manipulation light (or referred to as addressing light)), to implement quantum state manipulation of the ions, and obtain quantum state information of the ions.

In a conventional technology, the manipulation light is strongly focused (for example, focused at a micrometer level). For example, the manipulation light is strongly focused by using a lens with a large numerical aperture (NA) in cooperation with another optical element. The NA is a dimensionless number, and is used to measure a capability of the lens to collect light. Addressing the ions by strongly focusing the manipulation light has poor scalability and high difficulty, and further requires a complex optical path design.

### SUMMARY

This application provides a particle trap system, to simplify and accurately implement particle addressing.

According to a first aspect, this application provides a particle trap system, where the particle trap system may include a trapping module, a first optical splitting module, and a first relative delay module. The trapping module is configured to trap at least two particles. The first optical splitting module is configured to split a received light beam into a first light beam and a second light beam. The first relative delay module is configured to adjust a delay amount for the first light beam and the second light beam to reach a first target particle, where an adjusted first light beam and an adjusted second light beam overlap at the first target particle, and the first target particle is at least one of the at least two particles trapped in the trapping module.

In a possible implementation, the delay amount is an absolute value of a difference between first flight time and second flight time, the first flight time is flight time of a photon of the first light beam on an optical propagation path of the first light beam, and the second flight time is flight time of a photon of the second light beam on an optical propagation path of the second light beam. Further, the first light beam and the second light beam overlap at the first target particle, so that the first target particle can be addressed, and the first target particle can be manipulated.

When the particle is an ion, the particle trap system may include but is not limited to an ion trap system.

Based on the foregoing solution, after splitting the received light beam, the optical splitting module obtains the first light beam and the second light beam, and adjusts, by using the first relative delay module, a delay amount for the first light beam and the second light beam to reach the first target particle, so that an overlapping position of the first light beam and the second light beam can be adjusted. In this way, the first light beam and the second light beam overlap (or are referred to as coincide) at different particles (that is, the overlapping position of the first light beam and the second light beam is aligned with different target particles). It may also be understood that, by controlling the photon flight time, the first light beam and the second light beam may be accurately controlled to be simultaneously aligned and illuminated on a particle, so that high-precision independent addressing can be implemented for different particles. In addition, based on the foregoing particle trap system, complexity of an optical path design can be simplified, thereby helping reduce noise of manipulation light, and further improving precision of manipulation of a particle.

In a possible implementation, the particle trap system may further include a light source module. The light source module may send the light beam based on a first pulse width, where a first space distance corresponding to the first pulse width is less than a spacing between any two adjacent particles in the at least two particles in the trapping module.

Because the first space distance corresponding to the first pulse width is less than the spacing between the any two adjacent particles, the first light beam and the second light beam can be shot on only one particle simultaneously, so that independent addressing can be implemented for a single particle.

Further, optionally, a second space distance corresponding to a time interval at which the light source module transmits two adjacent light beams is greater than the spacing between any two of the at least two particles in the trapping module.

In this way, in a case in which independent addressing of a single particle is implemented, particles around the addressed particle are not affected.

For example, the light source module may include but is not limited to a femtosecond pulse laser.

In a possible implementation, the first relative delay module is specifically configured to change an optical path of the received first light beam and/or an optical path of the received second light beam.

For example, the first relative delay module may be located on an optical propagation path of the first light beam, and correspondingly, the first relative delay module is specifically configured to change the optical path of the received first light beam. For another example, the first relative delay module may be located on an optical propagation path of the second light beam, and correspondingly, the first relative delay module is specifically configured to change the optical path of the received second light beam. For another example, the first relative delay module may be located on an optical propagation path of the first light beam and the second light beam, and correspondingly, the first relative delay module is specifically configured to change the optical path of the received first light beam and change the optical path of the received second light beam.

By changing the optical path of the first light beam and/or the optical path of the second light beam, the delay amount for the first light beam and the second light beam to reach the first target particle may be adjusted, and independent addressing of different particles may be implemented.

In a possible implementation, the first relative delay module includes a first drive component and an optical path adjustment component. The first drive component is configured to send a first drive signal to the optical path adjustment component based on a received first control signal, where the first control signal is determined based on a position of the first target particle. The optical path adjustment component is configured to change based on the first drive signal, the optical path of the received first light beam and/or the optical path of the received second light beam.

The first drive component drives the optical path adjustment component, so that the optical path of the first light beam and/or the optical path of the second light beam can be changed, and the delay amount for the first light beam and the second light beam to reach the first target particle may be adjusted.

In a possible implementation, the optical path adjustment component includes a galvanometer and a reflection element. The galvanometer is configured to: change the optical path of the received first light beam and/or the optical path of the received second light beam based on the first drive signal, and propagate the first light beam whose optical path is changed and/or the second light beam whose optical path is changed to the reflection element. The reflection element is configured to reflect, to the first target particle, the received first light beam whose optical path is changed and/or the received second light beam whose optical path is changed.

For example, the galvanometer may include but is not limited to a micro electro-mechanical system (MEMS) reflector, an MEMS waveguide, or the like. The reflection element may include but is not limited to a reflector, a prism, and the like.

In a possible implementation, the particle trap system further includes a first optical path module and a second optical path module. The first optical path module is configured to propagate, to the first target particle, the first light beam or the first light beam whose optical path is changed. The second optical path module is configured to propagate, to the first target particle, the second light beam or the second light beam whose optical path is changed.

Further, the first optical path module includes a first modulation component, configured to modulate a time sequence and/or a frequency of the first light beam; and/or the second optical path module includes a second modulation component, configured to modulate a time sequence and/or a frequency of the second light beam.

The first modulation component may be used to control the time sequence and/or the frequency of the first light beam, and the second modulation component may be used to control the time sequence and/or the frequency of the second light beam, thereby implementing quantum computing that meets a requirement.

Further, the first optical path module further includes a first polarization component, and the second optical path module further includes a second polarization component. The first polarization component is configured to convert a polarization state of the received first light beam into left hand circularly polarized light, and the second polarization component is configured to convert a polarization state of the received second light beam into right hand circularly polarized light; or the first polarization component is configured to convert a polarization state of the received first light beam into right hand circularly polarized light, and the second polarization component is configured to convert a polarization state of the received second light beam into left hand circularly polarized light.

Because polarization states of the first light beam and the second light beam affect coupling strength of the first light beam and the second light beam, and further affect quantum efficiency of manipulation of the particle, when a first light beam whose polarization state is right hand circularly polarized light and a second light beam whose polarization state is left hand circularly polarized light (or a first light beam whose polarization state is left hand circularly polarized light and a second light beam whose polarization state is right hand circularly polarized light) simultaneously reach a target particle, quantum efficiency of the particle is improved.

In a possible implementation, the particle trap system further includes a second light beam splitting module, and the first relative delay module includes N relative delay submodules, where N is an integer greater than 1. The second light beam splitting module is configured to split the second light beam that is from the first optical splitting module into N third light beams, where one third light beam corresponds to one relative delay submodule. The relative delay submodule is configured to change a delay amount for the first light beam and the third light beam to reach the first target particle.

By using the second light beam splitting module and the N relative delay submodules, the N third light beams may sequentially overlap with the first light beam at different particles, so that addressing may be performed on a plurality of particles. In addition, during quantum computing, parallel multi-bit computing may be performed, and more quantum algorithms may be applied.

In a possible implementation, the particle trap system further includes a first light beam recovery module and a second relative delay module; the first light beam recovery module is configured to propagate a fourth light beam to the second relative delay module, where the fourth light beam is remaining light of the first light beam after the first target particle is manipulated or remaining light of the second light beam after the first target particle is manipulated; the second relative delay module is configured to adjust a delay amount for the fourth light beam and the first light beam to reach a second target particle, where an adjusted fourth light beam and an adjusted first light beam overlap at the second target particle, and the second target particle is a particle other than the first target particle in the at least two particles; and an optical path of the fourth light beam is equal to a sum of k times the second space distance and two times a spacing between the first target particle and the second target particle, where k is a positive integer. It may also be understood that the optical path of the fourth light beam=k×the second space distance+2×(a spacing between the first target particle and the second target particle).

By adjusting delay amounts of the second relative delay module at different moments, delay amounts of two adjacent fourth light beams may be controlled, to implement sequential addressing of different particles. In addition, a manner of arranging and combining the addressed particles (or referred to as a sequence of addressing particles) may be further changed. Further, after remaining energy of the first light beam or the second light beam after the particle is manipulated is recovered and utilized, energy utilization is improved, and in multi-particle simultaneous addressing, power consumption of the particle trap system and system complexity may be further reduced.

Further, the second relative delay module is configured to change the optical path of the fourth light beam, and propagate, to the second optical path module, the fourth light beam whose optical path is changed. The second optical path module is further configured to propagate, to the second target particle, the fourth light beam whose optical path is changed.

The fourth light beam is propagated to the second optical path module, and then propagated to the second target particle through the second optical path module. In an initialization process, an initialization process of directly propagating the fourth light beam to a propagation direction of the second target particle may be omitted.

In a possible implementation, the particle trap system further includes a first filtering module, configured to: in first time domain, allow the fourth light beam that is from the first light beam recovery module to pass through, and propagate the fourth light beam to the second relative delay module.

By controlling the first filtering module, the fourth light beam can be allowed to pass through in first time domain or blocked from passing through in time domain other than the first time domain.

In a possible implementation, the particle trap system further includes a second light beam recovery module; the second light beam recovery module is configured to: return, in second time domain, the first light beam that is from the first optical path module to the first optical path module, where the first light beam that is returned to the first optical path module and the first light beam that is from the first optical splitting module form a pulse sequence; and propagate, in third time domain, the pulse sequence formed by the first light beam to the first trapping module. Alternatively, the second light beam recovery module is configured to: return, in fourth time domain, the first light beam that is from the second optical path module to the second optical path module, where the second light beam that is returned to the second optical path module and the second light beam that is from the first optical splitting module form a pulse sequence; and propagate, in fifth time domain, the pulse sequence formed by the second light beam to the first trapping module.

The pulse sequence formed by the first light beam overlaps with the second light beam at different particles, or the pulse sequence formed by the second light beam overlaps with the first light beam at different particles, so that different particles can be manipulated.

### BRIEF DESCRIPTION OF DRAWINGS

FIG. 1a is a schematic diagram of an ion quantum state according to this application;

FIG. 1b is a schematic diagram of a relationship between a Rabi intensity and a light beam coordinate according to this application;

FIG. 1c is a schematic diagram of a principle of manipulating an ion via Raman scattering light according to this application;

FIG. 1d is a schematic diagram of two light beams overlapping at a position of an ion according to this application;

FIG. 1e is a schematic diagram of a process of trapping ions according to this application;

FIG. 2 is a schematic diagram of an architecture of a particle trap system according to this application;

FIG. 3a is a schematic diagram of a structure of an ion trapping module according to this application;

FIG. 3b is a schematic diagram of a principle of trapping ions according to this application;

FIG. 3c is a schematic diagram of a working principle of a 3D-MOT according to this application;

FIG. 3d is a schematic diagram of a structure of an atom trapping module according to this application;

FIG. 3e is another schematic diagram of a structure of an atom trapping module according to this application;

FIG. 4a is a schematic diagram of distribution of ions trapped by a trapping module according to this application;

FIG. 4b is another schematic diagram of distribution of ions trapped by a trapping module according to this application;

FIG. 4c is still another schematic diagram of distribution of ions trapped by a trapping module according to this application;

FIG. 4d is yet another schematic diagram of distribution of ions trapped by a trapping module according to this application;

FIG. 4e is still yet another schematic diagram of distribution of ions trapped by a trapping module according to this application;

FIG. 4f is further another schematic diagram of distribution of ions trapped by a trapping module according to this application;

FIG. 5 is a schematic diagram of a pulse laser light according to this application;

FIG. 6 is a schematic diagram of a splitting principle of a polarizing beam splitter according to this application;

FIG. 7 is a schematic diagram of a relationship between a delay amount and an overlapping position of two light beams according to this application;

FIG. 8a is a schematic diagram of a structure of a first relative delay module according to this application;

FIG. 8b is another schematic diagram of a structure of a first relative delay module according to this application;

FIG. 8c is still another schematic diagram of a structure of a first relative delay module according to this application;

FIG. 8d is yet another schematic diagram of a structure of a first relative delay module according to this application;

FIG. 9 is another schematic diagram of an architecture of an ion trap system according to this application;

FIG. 10 is a schematic flowchart of an ion manipulation method according to this application;

FIG. 11 is still another schematic diagram of an architecture of an ion trap system according to this application;

FIG. 12 is yet another schematic diagram of an architecture of an ion trap system according to this application;

FIG. 13 is a schematic diagram of a pulse sequence formed by a fourth light beam according to this application;

FIG. 14 is another schematic diagram of a relationship between a delay amount and overlapping of a first light beam and a fourth light beam according to this application;

FIG. 15 is still yet another schematic diagram of an architecture of an ion trap system according to this application; and

FIG. 16 is a schematic method flowchart of an ion manipulation method according to this application.

### DESCRIPTION OF EMBODIMENTS

The following describes in detail embodiments of this application with reference to accompanying drawings.

Some terms in this application are described below. It should be noted that these explanations are for ease of understanding by a person skilled in the art, and are not intended to limit the protection scope claimed by this application.

### 1. Femtosecond Pulse Laser Light

A femtosecond pulse laser light is a laser light that runs in a form of a pulse and lasts for a short time, with only a few femtoseconds (fs). One femtosecond is equal to 10⁻¹⁵ seconds, that is, one femtosecond is one billionth of one second. The femtosecond pulse laser light is thousands of times shorter than the shortest pulse obtained by electronic methods.

### 2. Excitation Transition

Excitation transition is a process in which an atom transits from a high energy level to a low energy level to emit a photon, or transits from a low energy level to a high energy level to absorb a photon.

### 3. Raman Scattering Light

Raman scattering light is a kind of scattering light. When an excited molecule, without being stayed in an excited state, releases energy at a same wavelength and by randomly changing a direction of incident light, it is referred to as scattering. When an excited molecule releases energy at a wavelength different from an original excitation light during scattering, it is referred to as Raman scattering light.

### 4. Rabi Oscillation Scanning

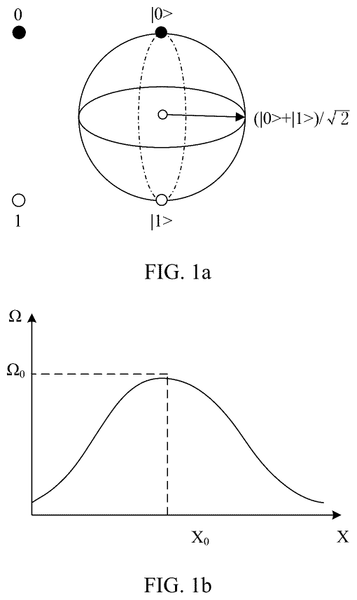

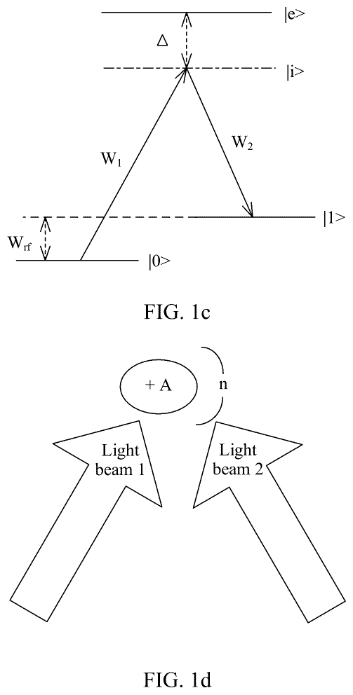

Rabi oscillation scanning is follows: Different oscillation signals are obtained by loading light beams with different lengths to a particle; an oscillation period T is obtained by fitting different oscillation signals corresponding to different lengths; and a Rabi intensity at a location may be determined based on a relationship Ω=1/T between the Rabi intensity and the oscillation period. Different Rabi intensities Ω may be obtained by changing a position illuminated by the light beam on the particle. That is, when the light beam illuminates on different positions on the particle, the obtained Rabi intensities Ω are also different. When the light beam is completely aligned with the particle, a measured Rabi intensity is the greatest. FIG. 1b is a schematic diagram of a relationship between a Rabi intensity and a light beam coordinate. When the light beam coordinate is X₀, a corresponding Rabi intensity is the largest, and is Ω₀. This indicates that when the light beam coordinate is X₀, a light beam is completely aligned with an illuminated particle.

The foregoing describes some terms in this application. The following describes technical features and principles in this application. It should be noted that these explanations are for ease of understanding by a person skilled in the art, and are not intended to limit the protection scope claimed by this application.

### 1. A Principle and Configuration of Manipulating an Ion Via Raman Scattering Light

FIG. 1c is a schematic diagram of a principle of manipulating an ion via Raman scattering light according to this application. Three solid lines represent three energy levels of the ion, |0> and |1> are ground state energy levels of the ion, an energy level difference between the two ground state energy levels is w_{rf}, and |e> is an excited state energy level. With illumination of light, the ion can absorb a photon and transit from a ground state to an excited state.

When two Raman scattering light beams simultaneously meet the following three relationships, excitation transition of the excited ion may be implemented, so that the ion (for example, a single ion or a plurality of ions) can be manipulated. Frequencies of the two Raman scattering light beams are respectively represented as w₁ and w₂.

Relationship 1: A frequency difference meets energy conservation: w₁−w₂=w_{rf}.

Relationship 2: Momentum meets momentum conservation.

Relationship 3: The two light beams interact with an ion at the same time, that is, the two light beams overlap at a position of the ion (refer to FIG. 1d).

It should be understood that due to light-excited ion transition, capability conservation needs to be satisfied. In addition, compared with directly transition from the ground state to the excited state, light-excited ion transition via the two Raman scattering light beams with the frequencies w₁ and w₂ have a specific frequency detuning Δ. When the detuning A is large enough, a single Raman scattering light beam cannot stimulate ion transition.

It should be noted that a principle of manipulating another particle (for example, an atom) via the Raman scattering light is the same as the principle of the foregoing ion control, and details are not described herein again.

### 2. A Process of Trapping Ions in a Trapping Module

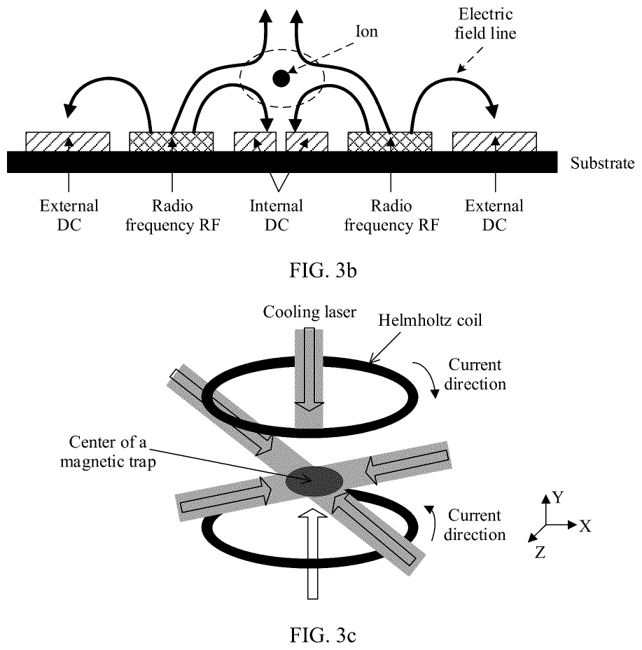

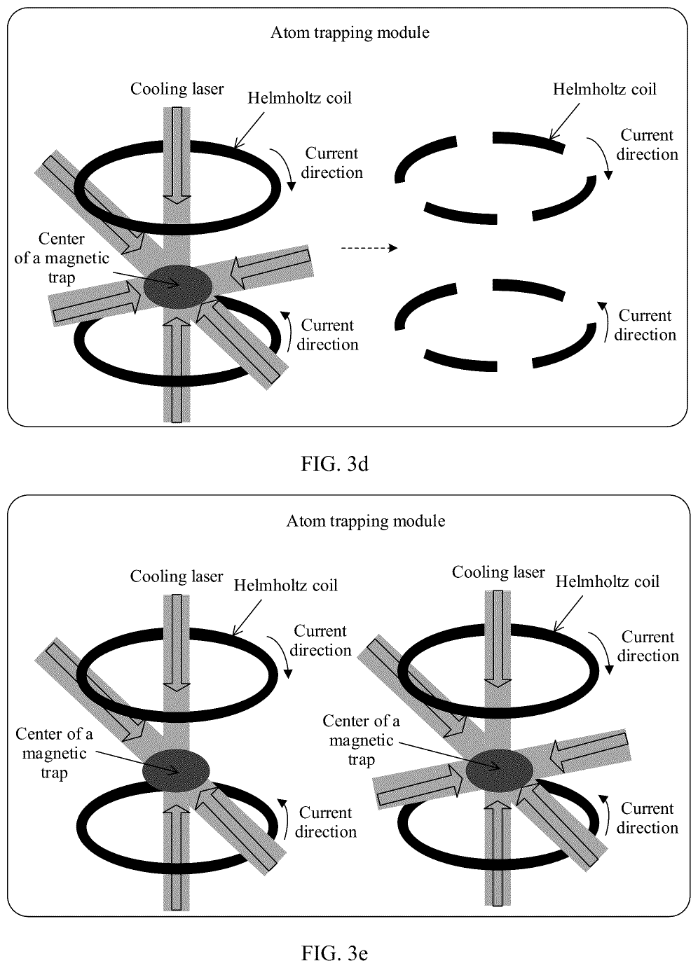

FIG. 1e is a schematic diagram of a process of trapping ions according to this application. An atom source heats an atom via electricity and/or light, generates an atom beam flow (or atomic vapor), ionizes the atom beam flow to obtain an ion, cools the ion, and traps the ion with an electrode, an electromagnetic field generation apparatus, and the like (refer to the following description in FIG. 3a). Further, the trapped ion interacts with manipulation light (for example, the two Raman scattering light beams) to achieve a specific quantum state. It should be understood that in FIG. 1e, for example, the trapped ion includes five ions.

As described in the background, currently, a lens with a large NA is mainly used to strongly focus manipulation light, so as to implement particle addressing. Specifically, a plurality of particles are trapped into a one-dimensional particle chain, and the manipulation light is divided into two channels. One channel is global Raman scattering light, and the other channel is independent Raman scattering light. Each independent Raman scattering light needs to be separately aligned with one particle to implement independent addressing. The independent Raman scattering light needs to be focused by using the lens with the large NA, to focus on a particle in the particle chain. As a result, addressing the particles by strongly focusing the manipulation light has poor scalability and high difficulty, and further requires a complex optical path design.

In view of this, this application provides a particle trap system. The particle trap system can accurately address particles by controlling photon flight time.

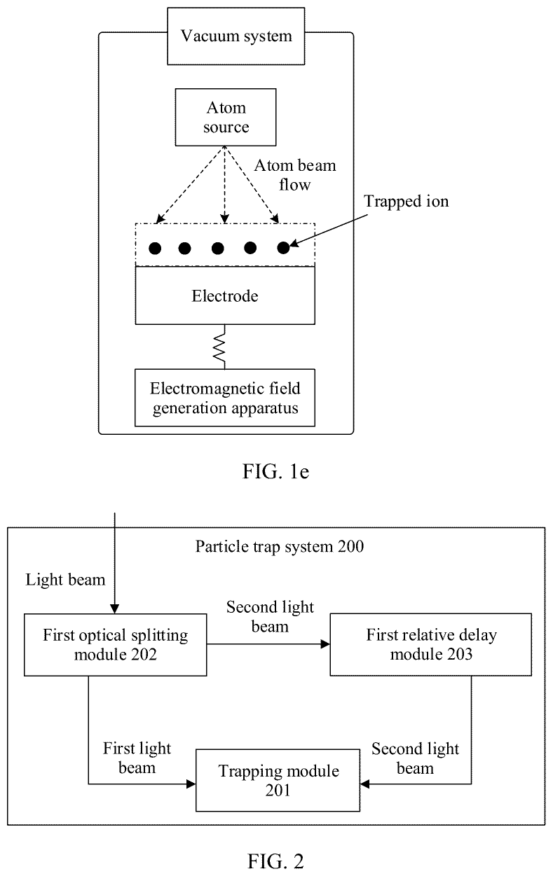

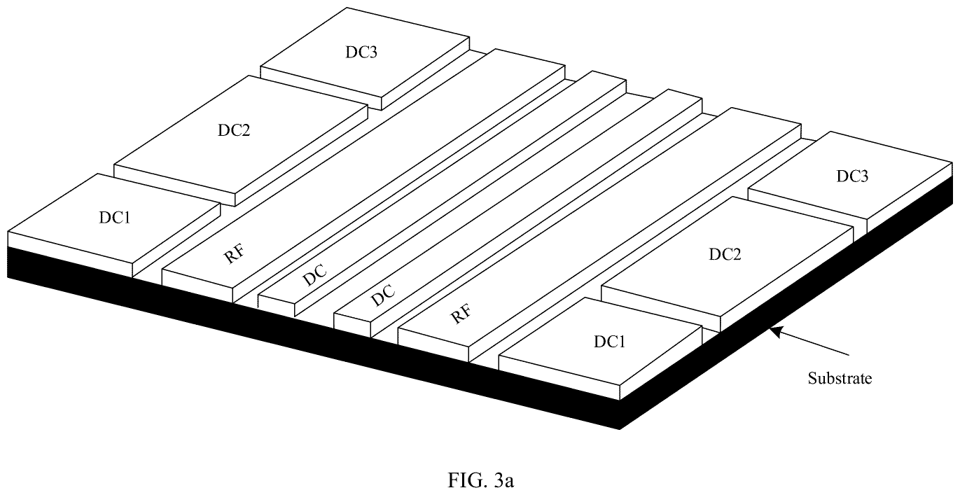

Based on the foregoing content, the following specifically describes the particle trap system provided in this application with reference to FIG. 2 to FIG. 15.

FIG. 2 is a schematic diagram of an architecture of a particle trap system according to this application. A particle trap system 200 may include a trapping module 201, a first optical splitting module 202, and a first relative delay module 203. The trapping module 201 is configured to trap at least two particles. The first optical splitting module 202 is configured to split a received light beam into a first light beam and a second light beam. The first relative delay module 203 is configured to adjust a delay amount for the first light beam and the second light beam to reach a first target particle, where an adjusted first light beam and an adjusted second light beam overlap at the first target particle, and the first target particle is at least one of the at least two particles trapped in the trapping module 201.

The delay amount is an absolute value of a difference between first flight time and second flight time, the first flight time is flight time of a photon of the first light beam on an optical propagation path of the first light beam, and the second flight time is flight time of a photon of the second light beam on an optical propagation path of the second light beam.

Based on the foregoing particle trap system, after splitting the received light beam, an optical splitting module obtains the first light beam and the second light beam, and adjusts, by using the first relative delay module, a delay amount for the first light beam and the second light beam to reach the first target particle, so that an overlapping position of the first light beam and the second light beam can be adjusted. In this way, the first light beam and the second light beam overlap (or are referred to as coincide) at different particles (that is, the overlapping position of the first light beam and the second light beam is aligned with different target particles). It may also be understood that, by controlling the photon flight time, the first light beam and the second light beam may be accurately controlled to be simultaneously aligned and illuminated on a particle, so that high-precision independent addressing can be implemented for different particles. In addition, based on the foregoing particle trap system, complexity of an optical path design can be further simplified, thereby helping reduce noise of manipulation light, improving precision of manipulating a particle, and further helping improve performance and scalability of quantum computing.

The first light beam and the second light beam may be two Raman scattering light beams, and also need to meet the foregoing three conditions that need to be met by the two Raman scattering light beams. It may also be understood that when the first light beam and the second light beam are aligned and illuminated to a same particle at the same time, quantum state manipulation may be performed on the particle. For example, an initial quantum state of the first target particle is |0>, and after the first light beam and the second light beam simultaneously reach the first target particle, the quantum state of the first target particle may be manipulated to 1>.

Further, optionally, the first light beam and the second light beam are two light beams separated by the optical splitting module for a same light beam, that is, the first light beam and the second light beam come from a same light beam, and coherence between the first light beam and the second light beam is high. It may be considered that the first light beam and the second light beam are basically similar to or even the same when being transmitted to the trapping module. The first light beam and the second light beam have a correlation, thereby helping to reduce noise generated on the particle after the first light beam and the second light beam overlap.

The following separately describes the functional modules shown in FIG. 2, to provide an example of a specific implementation. For ease of description, the trapping module, the first optical splitting module, and the first relative delay module in the following are not marked with a number.

### 1. Trapping Module

In a possible implementation, the trapping module is configured to trap a particle. The particles may include but are not limited to an ion, an atom, and the like. It may also be understood that the trapping module may be an ion trapping module, or may be an atom trapping module.

Structure 1: The trapping module is the ion trapping module.

FIG. 3a is a schematic diagram of a structure of a trapping module for trapping ions according to this application. The trapping module includes a direct current (DC) electrode and a radio frequency (RF) electrode. The DC electrode and the RF electrode may be disposed on a substrate (for example, the electrode may be etched on the substrate by using microprocessing, a printed circuit, or the like). The DC electrode and the RF electrode may also be referred to as a trapping electrode. Further, the trapping module may further include an electromagnetic field generation apparatus (for example, a power supply). Both the DC electrode and the RF electrode are connected to an electromagnetic field generation apparatus (for example, the power supply). After being powered on, the RF electrode may generate an alternating radio frequency electric field, the DC electrode may generate a direct current field, and the radio frequency electric field and the direct current field work together to generate a trap potential trap for trapping ions, to trap the ions. For a principle, refer to FIG. 3b. A curve in FIG. 3b represents distribution of an electric field line at a moment. After half a radio frequency period, the electric field line is reversed, and the ions is in the trap potential trap whose electric field line changes rapidly. Average effect is that the ion is stably trapped on a surface of the electrode by the trap potential trap. It should be understood that the foregoing structure of the trapping module is merely an example, and any structure that can implement ion trapping falls within the protection scope of this application. For example, the trapping module may further include a “Paul ion trap” (also referred to as a quadrupole ion trap). The quadrupole ion trap may be implemented by adding a four-stage rod structure to front and rear end covers. Ions are focused on one line, which may increase an ion storage amount and help avoid space charge effect and simplify an electrode structure. The quadrupole ion trap is also referred to as a linear ion trap. For another example, the trapping module may further include a blade trap, a surface trap, or the like. This is not limited in this application.

Structure 2: The trapping module is the atom trapping module.

In a possible implementation, the atom trapping module is mainly configured to capture and trap an atom in a high-speed atom beam flow from an atomic source. For example, the atom trapping module may include a three-dimension magneto-optical trap (3D-MOT). FIG. 3c is a schematic diagram of a working principle of a 3D-MOT according to this application. A working principle of the 3D-MOT is to add three pairs of cooling laser lights (that is, six cooling laser lights in total) whose frequencies are close to an atomic energy level difference to a gradient magnetic trap generated by a pair of Helmholtz coils carrying a reverse current. Two cooling laser lights are a pair. Each pair of cooling laser lights have opposite incident directions. The three pairs of cooling laser lights are emitted from three orthogonal directions (for example, three directions XYZ), where an intersection point is located at a center of the magnetic trap. The atom in the atom beam flow continuously absorbs a photon with reverse momentum, and is subjected to a reverse force of the cooling laser light. As a result, the atom is continuously decelerated, and finally is cooled and trapped in the center of the magnetic trap.

The following provides examples of three possible structures of the atom trapping module.

Structure 2.1: The atom trapping module includes a 3D-MOT and an evaporative cooling unit.

FIG. 3d is a schematic diagram of a structure of an atom trapping module according to this application. The atom trapping module may include a 3D-MOT and an evaporative cooling unit. The 3D-MOT may be configured to trap an atom beam flow from an atomic source; and the evaporative cooling unit may be configured to further evaporatively cool an atom from the 3D-MOT. The trapped atom may be cooled down through the foregoing further evaporative cooling, so that a phase space density of the trapped atom in the atom trapping module can be increased. The evaporative cooling unit may be a pure magnetic trap or a pure optical trap. For example, if the evaporative cooling unit is the pure magnetic trap, the atom beam flow is trapped under an action of a cooling laser light and a magnetic field of the 3D-MOT, to obtain an atom within a specific temperature range, and then the atom is transferred to the pure magnetic trap for evaporative cooling, to further cool the atom. The pure magnetic trap is a structure in which a magnetic field gradient of a Helmholtz coil is rapidly increased after the cooling laser light is turned off, and the atom can be trapped only by using the magnetic field. It should be understood that because the atom has a large quantity of energy levels, an RF coil may emit a radio frequency with a frequency scanning change, and continuously excite the atom in a trapped state in the magnetic field to a non-trapped state. In addition, only an atom with a high temperature can be in the non-trapped state at a high probability. Therefore, in an evaporative cooling process, an atom with a higher temperature is continuously removed from atoms, and remaining atoms achieve heat balance through elastic collision. Then, the process is repeated, to achieve effect of cooling the atom. The pure optical trap is a structure of an atom trapped by an optical trap formed by a far infrared laser light. A trapping principle is similar to that of a 1064 nm optical trap laser light. An evaporative cooling process is to achieve the purpose of cooling the atom by continuously reducing the laser light intensity.

Structure 2.2: The atom trapping module includes a 3D-MOT and a 2D-MOT.

FIG. 3e is another schematic diagram of a structure of an atom trapping module according to this application. The atom trapping module may include a 2D-MOT and a 3D-MOT. The 2D-MOT is configured to cool and converge atom beam flows from an atomic source, and spray the cooled and converged atom beam flows to the 3D-MOT. The 3D-MOT is configured to cool the cooled and converged atom beam flows from the 2D-MOT again, to implement atom trapping. The higher the rate of the atom beam flow, the more difficult it is for the atom trapping module to trap the atom. Therefore, a high-speed atom beam flow may be first sprayed to the 2D-MOT, and a rate of the atom beam flow is reduced in advance by using the 2D-MOT, to form a low-speed atom beam flow. In addition, the 2D-MOT may further flow the atom beam flow from one dimension to the 3D-MOT, that is, aggregation of the atom beam flow may be further implemented. In this way, the 3D-MOT may make it easier to trap the atoms in the atom beam flow, thereby increasing a quantity of atoms trapped by the atom trapping module. It should be noted that, compared with the 3D-MOT, the 2D-MOT does not have a cooling laser light constraint in one dimension, and cools the atom beam flow only in two dimensions (two dimensions YZ are used as an example in FIG. 3e), and the atom is discharged from a remaining dimension (Z) to form a low-speed atom beam flow. For other details, refer to the description of FIG. 3a, and details are not described herein again.

Structure 2.3: The atom trapping module includes a 2D-MOT, a 3D-MOT, and an evaporative cooling unit.

The structure 2.3 may be understood as a combination of the foregoing structure 2.1 and the foregoing structure 2.2. For a detailed structure, refer to descriptions of the foregoing structure 2.1 and the foregoing structure 2.2, and details are not described herein again.

It should be noted that, to trap an atom, the atom trapping module needs to optimize various parameters (for example, power of the cooling laser light, a frequency of the cooling laser light, polarization of the cooling laser light, a magnetic field size, and a time sequence of the cooling laser light and the magnetic field that are required by the 3D-MOT).

In the following description, for ease of solution description, an example in which the particle trapped in the trapping module is an ion, an example in which the particle trap system is an ion trap system, and an example in which the trapping module is an ion trapping module are used for description.

In a possible implementation, the trapped (or referred to as bound) ion in the trapping module may be distributed in one dimension, or may be distributed in two dimensions, or may be distributed in three dimensions. Details are separately described below.

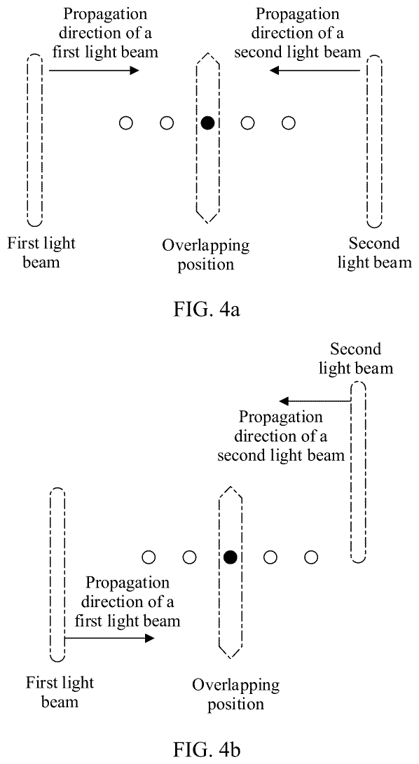

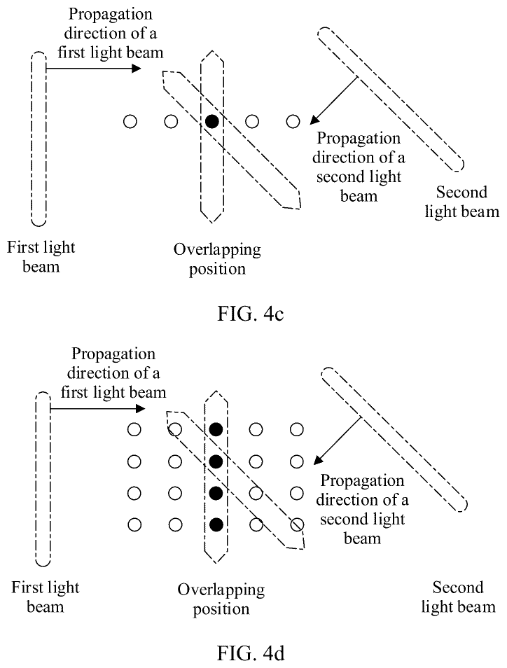

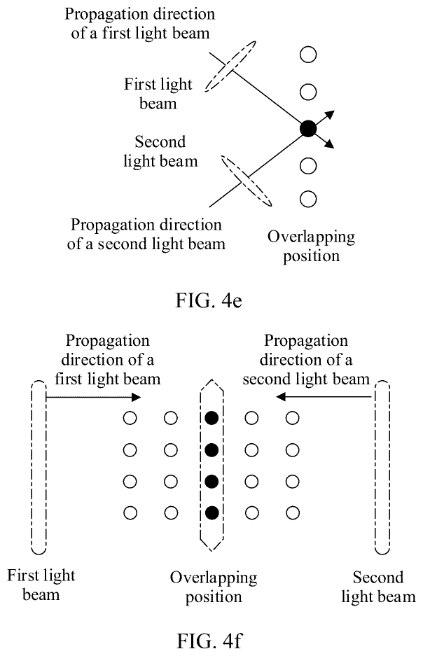

FIG. 4a is a schematic diagram of distribution of ions trapped by a trapping module according to this application. The trapped ions in the trapping module are distributed in one dimension, and may form a one-dimensional ion chain. A spacing between any two adjacent ions in the one-dimensional ion chain may be equal or may be unequal. It should be understood that FIG. 4a is described by using an example in which there are five ions and spacings between the ions are equal.

In a possible implementation, when the trapped ions are distributed in one dimension, a first light beam and a second light beam may implement independent addressing of a single ion. Specifically, a propagation direction of the first light beam and a propagation direction of the second light beam may be parallel and opposite (refer to FIG. 4a or FIG. 4b); or may have an included angle (refer to FIG. 4c). The included angle is greater than 90° and less than 180°. It should be noted that the propagation direction of the first light beam may also be referred to as a direction of the first light beam, and the propagation direction of the second light beam may also be referred to as a direction of the second light beam.

FIG. 4d is yet another schematic diagram of distribution of ions trapped by a trapping module according to this application. The trapped ions in the trapping module are distributed in two dimensions. It should be understood that two-dimensional distribution may also be irregular distribution. In FIG. 4d, regular two-dimensional distribution is used as an example. In other words, in FIG. 4d, an example in which two-dimensional ions are distributed in a 5×4 array is used. This is not limited in this application.

In a possible implementation, when the trapped ions are distributed in the two dimensions, the first light beam and the second light beam may implement independent addressing of a single ion. Specifically, there may be an included angle between the propagation direction of the first light beam and the propagation direction of the second light beam (refer to FIG. 4d or FIG. 4e), and the included angle is greater than 90° and less than 180°. Alternatively, the first light beam and the second light beam may be in a surface perpendicular to a surface on which the two-dimensional ions are located, and the propagation direction of the first light beam and the propagation direction of the second light beam are in a same straight line and are propagated. An overlapping area of the second light beam and the second light beam is slightly greater than a size of the ion.

In another possible implementation, when the trapped ions in the trapping module are distributed in the two dimensions, addressing of single-chain ions may also be implemented by using the first light beam and the second light beam, that is, the overlapping area of the first light beam and the second light beam may cover a plurality of ions. Specifically, the propagation direction of the first light beam and the propagation direction of the second light beam may be on a same straight line and propagate relative to each other (refer to FIG. 4f). Alternatively, there may be an included angle between the propagation direction of the first light beam and the propagation direction of the second light beam, and the included angle is greater than 90° and less than 180°. Specifically, an overlapping area of the first light beam and the second light beam may cover a plurality of ions. It should be noted that, when a spatially overlapping part of the first light beam and the second light beam is a line segment, a size of the line segment depends on a size of a cross section of the light beam. In addition, because a spacing between adjacent ions is usually at a micrometer level, for simultaneous addressing of the single-chain ions, a line segment that overlaps with the first light beam and the second light beam may overlap with the single-chain ions.

In a possible implementation, types of trapped ions in the trapping module may be the same, or may be different, or may be partially the same. For example, the trapped ions may include but are not limited to any one or any combination of a ytterbium (Yb) ion, a calcium (Ca) ion, a beryllium (Be) ion, and the like. Different types of ions emit fluorescence at different wavelengths.

It should be noted that, to prevent another external particle or the like from colliding with the trapped ion, thereby damaging a quantum state of the trapped ion or even causing loss of the trapped ion, the trapping module usually needs to be disposed in a vacuum system or an ultra-high vacuum system (or referred to as a vacuum cavity), to isolate the trapped ion from an external environment.

### 2. Light Source Module

In a possible implementation, the light source module is configured to transmit a light beam based on a first pulse width. In time domain, for example, the first pulse width may be on a femtosecond (fs) order. Further, a time interval between two adjacent pulses (that is, two adjacent light beams transmitted by the light source module) is on an ns order or above the ns order. In space, a first space distance (dL) corresponding to the first pulse width is less than a spacing between any two adjacent ions, and generally, dL is on a micrometer (um) order. Further, a second space distance DL corresponding to a time interval between transmitting two adjacent pulses by the light source module is greater than a spacing between any two ions in the at least two ions in the trapping module, and generally, DL is on a meter order. Because the first space distance corresponding to the first pulse width is less than the spacing between any two adjacent ions, and the second space distance corresponding to the time interval between the two adjacent pulses is greater than the spacing between any two ions in the at least two ions in the trapping module, independent addressing of a single ion can be implemented, and no impact is caused on ions around the addressed ions.

It should be noted that, that the second space distance is greater than the spacing between any two ions in the at least two ions in the trapping module usually means that the second space distance is greater than a spacing between any two ions belonging to a same chain, or the second space distance is greater than a spacing between any two ions belonging to a same area.

Further, optionally, the first space distance corresponding to the first pulse width may be represented by using the following formula 1, and the second space distance corresponding to two adjacent pulses may be represented by using the following formula 2.

$$d L = C \times dt \qquad Formula 1$$

$$DL = C \times Dt \qquad Formula 1$$

dL represents the first space distance corresponding to the first pulse width. C represents a speed of light, and is a constant of 3×10⁸ m/s. dt represents the first pulse width. DL represents the corresponding second space distance between two adjacent pulses. Dt represents the time interval between the two adjacent pulses.

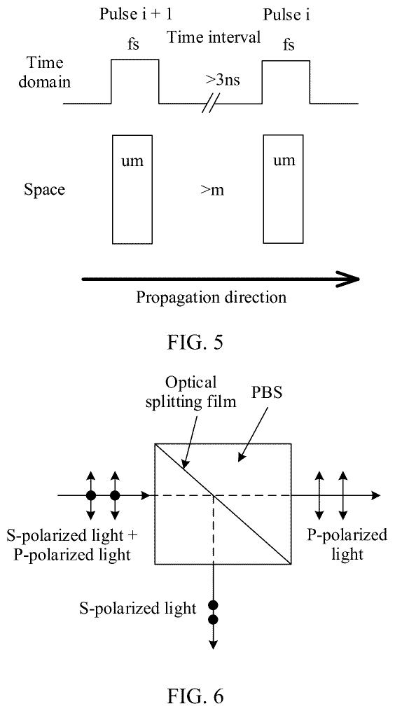

FIG. 5 is a schematic diagram of a pulse laser light according to this application. Pulse widths of an i^{th} pulse and an (i+1)th pulse are both a first pulse width, and are on an fs order. The first pulse width corresponds to a first space distance dL=C×dt=3×10⁸ m/s×10⁻¹⁵s=3×10⁻⁷ m=3 μm. A time interval between the i^{th} pulse and the (i+1)^{th} pulse is greater than 3 ns. A corresponding second space distance between two adjacent pulses is DL=C×Dt=3×10⁸ m/s×3 ns=3×10⁸ m/s×3×10⁻⁹ s=0.9 m.

Further, optionally, a spacing between spatially adjacent overlapping positions of the first light beam and the second light beam is usually on a meter order, where the first light beam and the second light beam may also be referred to as two pulses that are opposite to each other. For example, by changing a delay amount for the first light beam and the second light beam to reach the first target ion, the first light beam and the second light beam may overlap at a position 1, or may overlap at a position 2. If the position 1 and the position 2 are two adjacent positions, a distance between the position 1 and the position 2 is usually on a meter order, and is far greater than a length of an ion chain trapped by the trapping module. Therefore, it may be noted that the first light beam and the second light beam can overlap at only one position in the ion chain, and do not affect other ions.

For example, the light source module may include but is not limited to: a femtosecond pulse laser, a picosecond laser, or an attosecond laser. A light beam transmitted by the femtosecond pulse laser is femtosecond pulse laser light, and a pulse width of the femtosecond pulse laser light is on a femtosecond (fs) order in time domain, so that a first space distance corresponding to the pulse width is less than a distance between any two adjacent ions in at least two ions. A repetition frequency is less than 1 GHz, so that a second space distance corresponding to a time interval between two adjacent light beams is greater than a distance between any two ions in the at least two ions. In space, a space distance corresponding to a pulse width of a femtosecond pulse laser light is on a um order, and a space distance (on a meter order) corresponding to an interval between two adjacent pulses is far greater than a total length of a common long ion chain.

It should be noted that the light source module may belong to an ion trap system, or may be independent of an ion trap system.

### 3. First Optical Splitting Module

In a possible implementation, the first optical splitting module may split a light beam from the light source module into a first light beam and a second light beam. It should be understood that the first light beam and the second light beam may be two channels of light, or may be more than two channels of light. In other words, the first optical splitting module may split a light beam from the light source module into two or more channels of light. From the perspective of the trapped ions, each ion can sense only one pair of light beams (that is, the first light beam and the second light beam). It may also be understood that two light beams that are simultaneously shot on a single ion are respectively referred to as the first light beam and the second light beam.

It should be noted that the first optical splitting module splits light beams based on intensity (or referred to as energy or referred to as amplitude) of a light beam from the light source module, to obtain the first light beam and the second light beam. The first light beam and the second light beam carry the same information, and both the first light beam and the second light beam carry the same information as the light beam transmitted by the light source module. A sum of strength of the first light beam and strength of the second light beam is equal to or approximately equal to strength of a light beam emitted by the light source module.

The following provides two possible structures of the first optical splitting module as an example.

Structure 1: The first optical splitting module may be a polarizing beam splitter (PBS).

FIG. 6 is a schematic diagram of a splitting principle of a polarizing beam splitter according to this application. The polarizing beam splitter may be plated with one or more layers of thin films on an oblique surface of a right-angle prism, and the layers are laminated by using an adhesive layer. An optical element uses a property that transmittance of P-polarized light is 1 and transmittance of S-polarized light is less than 1 when a light beam is incident at a Brust angle. After a light beam passes through a thin film for a plurality of times at the Brust angle, a P-polarized component is completely transmitted and an S-polarized component is reflected (at least 90%). For example, the polarizing beam splitter may split incident light (including the P-polarized light and the S-polarized light) into horizontally polarized light (that is, the P-polarized light) and vertically polarized light (that is, the S-polarized light). The P-polarized light is completely transmitted, the S-polarized light is reflected at an angle of 45 degrees, and an emergent direction of the S-polarized light and an emergent direction of the P-polarized light form an angle of 90 degrees. It may also be understood that the PBS has transmission and reflection features. Generally, a reflectivity of the PBS for the S-polarized light is greater than 99.5%, and a transmittance of the PBS for the P-polarized light is greater than 91%.

It should be noted that the polarizing beam splitter may also be another possible optical splitting prism (BS) or an optical splitting plate. The optical splitting prism is formed by plating one or more layers of thin films (that is, optical splitting films) on a surface of the prism. The optical splitting plate is formed by plating one or more layers of thin films (that is, optical splitting films) on a surface of a glass plate. Both the optical splitting prism and the optical splitting plate use different transmittances and reflectivities of a light beam emitted by the thin film, to implement light splitting on a light beam propagated by a light source module.

It should be further noted that, if a light beam from the light source module needs to be split into more than two light beams, the first optical splitting module may be a PBS array.

Structure 2: The first optical splitting module may be a diffractive optical element (DOE).

In a possible implementation, the DOE may divide a light beam from the light source module into the first light beam and the second light beam. Propagation directions of the first light beam and the second light beam may be different or may be the same, and may be specifically determined based on actual application. It may be understood that a quantity of first light beams and a quantity of second light beams that are split by the DOE, and a spacing between the first light beam and the second light beam may be determined by a physical structure of the DOE.

It should be noted that the foregoing structure of the first optical splitting module is merely an example, and this is not limited in this application. Any structure that can implement splitting of a light beam from the light source module into the first light beam and the second light beam falls within the protection scope of this application. For example, the optical splitting module may also be a punched reflector, and the punched reflector is a reflector with a hole. A hole of the punched reflector may enable a part of a light beam from the light source module to pass through, to obtain the first light beam, and a reflector of the punched reflector may reflect a part of a light beam from the light source module, to obtain the second light beam. Alternatively, a hole of the punched reflector may enable a part of a light beam from the light source module to pass through, to obtain the second light beam, and a reflector of the punched reflector may reflect a part of a light beam from the light source module, to obtain the first light beam.

### 4. First Relative Delay Module

In a possible implementation, the first relative delay module is configured to control a delay amount (or referred to as a time difference) for the first light beam and the second light beam to reach a to-be-manipulated target ion. The delay amount determines a position at which the first light beam and the second light beam overlap. When the first light beam and the second light beam overlap at a target ion, manipulation on the target ion may be implemented. It may also be understood that, by using the first relative delay module, flight time of a light beam (the first light beam or the second light beam) passing through the first relative delay module may be adjusted, to adjust the overlapping position of the first light beam and the second light beam. It should be noted that the delay amount is determined based on the position of the target ion that needs to be manipulated. For details, refer to the description of an ion trap initialization process.

Specifically, the first relative delay module may be located on an optical propagation path of the first light beam, and may change an optical path of the first light beam, to change the delay amount for the first light beam and the second light beam to reach the first target ion. Further, the first light beam whose optical path is changed and the second light beam whose optical path is changed simultaneously reach the first target ion. Alternatively, the first relative delay module may be located on an optical propagation path of the second light beam, and may change an optical path of the second light beam, to change the delay amount for the first light beam and the second light beam to reach the first target ion. Further, the second light beam whose optical path is changed and the first light beam whose optical path is changed simultaneously reach the first target ion. Alternatively, the first relative delay module may be located on an optical propagation path of the first light beam and the second light beam, and may change an optical path of the first light beam and an optical path of the second light beam, to change the delay amount for the first light beam and the second light beam to reach the first target ion. Further, the first light beam whose optical path is changed and the second light beam whose optical path is changed simultaneously reach the first target ion. It may be understood that, when the first light beam and the second light beam overlap with the first target ion, a change amount of an optical path of the first light beam may be the same as or different from a change amount of an optical path of the second light beam.

It should be noted that a correspondence exists between the delay amount for the first light beam and the delay amount for the second light beam to reach the first target ion and the position of the first target ion. The correspondence may be determined in the ion trap initialization process. For details, refer to the description of the ion trap initialization process.

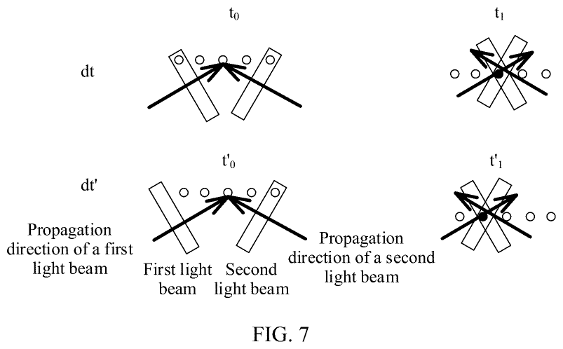

FIG. 7 is a schematic diagram of a relationship between a delay amount and an overlapping position of two light beams according to this application. A sphere represents an ion trapped by the trapping module. In this example, a one-dimensional ion chain including five ions is used as an example. Arrows respectively represent a propagation direction of a first light beam and a propagation direction of a second light beam, and rectangles represent the first light beam and the second light beam. If a delay amount of the first light beam and the second light beam is dt, the first light beam and the second light beam do not overlap at any ion at a moment t₀, and reach a third ion at a moment t₁ at the same time. It may also be understood that, when the delay amount of the first light beam and the second light beam is dt, the first light beam and the second light beam overlap at the third ion, and the third ion is the first target ion. If the delay amount of the first light beam and the second light beam is dt′, the first light beam and the second light beam do not overlap at any ion at the moment t₀, and reach a second ion at a moment t₁′ at the same time. It may also be understood that, when the delay amount of the first light beam and the second light beam is dt′, the first light beam and the second light beam overlap at the second ion, and the second ion is the first target ion.

Based on this, by controlling the delay amount for the first light beam and the second light beam to reach the first target ion, a position at which the first light beam and the second light beam overlap may be adjusted, so that independent addressing of different ions can be implemented. It may also be understood that, when the delay amount for the first light beam and the second light beam to reach the target ion changes, the first light beam and the second light beam simultaneously illuminate different ions.

In a possible implementation, the first relative delay module includes a first drive component and an optical path adjustment component. The first drive component is configured to send a first drive signal to the optical path adjustment component based on a received first control signal, where the first control signal is determined based on the position of the first target ion. The optical path adjustment component is configured to change the optical path of the received first light beam and/or the optical path of second light beam based on the first drive signal.

Further, optionally, in a time division addressing scenario, the first drive component may input different first drive signals to the optical path adjustment component at different moments, to control overlapping of the first light beam and the second light beam at an ion. It may also be understood that the delay amount of the first relative delay module may be controlled with high precision by using the first drive signal of the first drive component.

For example, the first drive component may be a voltage source, and the corresponding first drive signal may be a voltage signal; or the first drive component may be a current source, and the corresponding first drive signal may be a current signal.

The following shows three possible structures of the optical path adjustment component as an example.

For ease of description of the solution, an example in which the light beam received by the first relative delay module is the second light beam is used for description in the following example. It should be understood that if the light beam received by the first relative delay module is the first light beam, the second light beam in the following example may be replaced with the first light beam.

Structure 1: The optical path adjustment component includes a galvanometer and a reflection element.

The galvanometer may include but is not limited to a micro electro-mechanical system (MEMS) reflector, an MEMS waveguide, or the like. The reflection element may include but is not limited to a reflector, a prism, and the like. The prism may be, for example, a right-angle prism. The right-angle prism is used as the reflection element, which helps improve utilization of the second light beam emitted into the first relative delay module. Further, the optical path of the second light beam may be changed by changing a position of the MEMS reflector, and the optical path of the second light beam may be changed by changing a position of the MEMS waveguide. It should be understood that a propagation direction of the second light beam after passing through the MEMS reflector remains unchanged.

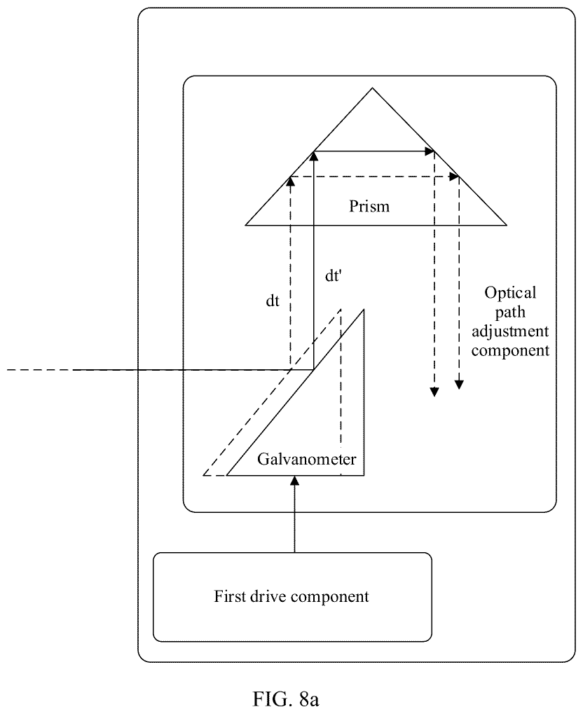

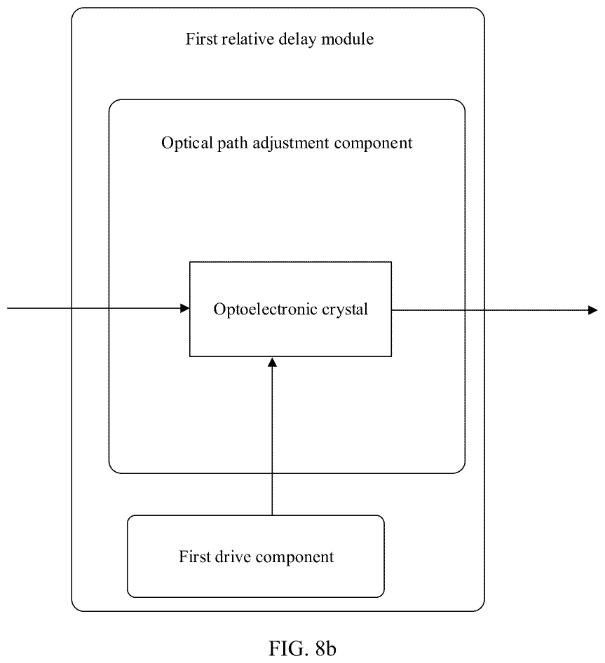

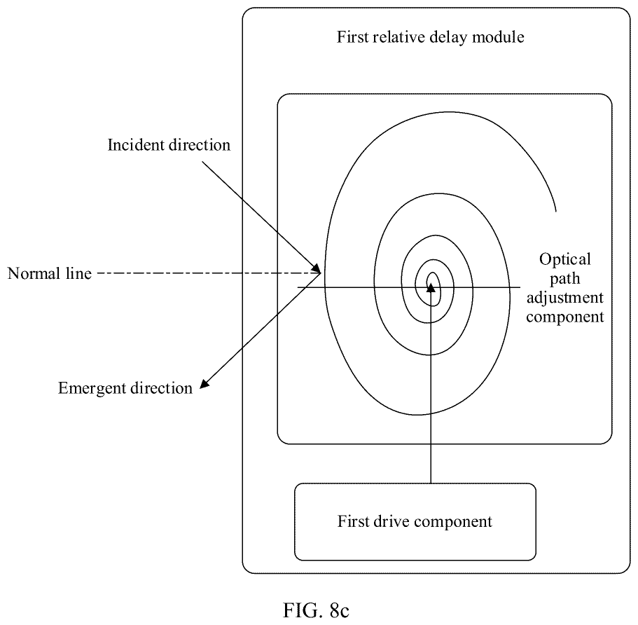

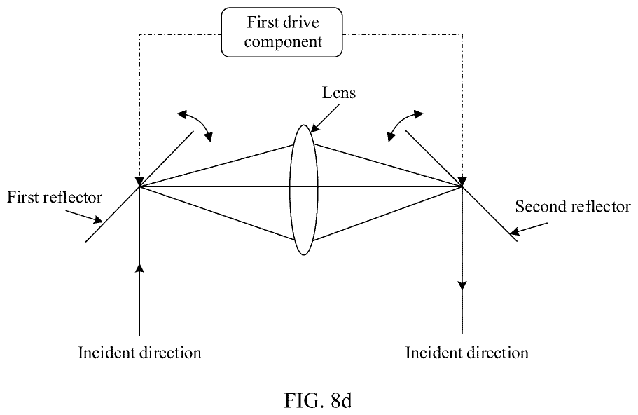

FIG. 8a is a schematic diagram of a structure of a first relative delay module according to this application. The first relative delay module includes a first drive component and an optical path adjustment component, and the optical path adjustment component includes a galvanometer and a prism. The galvanometer reflects a received second light beam to the prism, and the prism totally reflects the second light beam from the galvanometer. It may also be understood that an optical path of the second light beam passing through the first relative delay module is: reflected by the galvanometer to a first right-angle surface of the prism, totally reflected by the first right-angle surface of the prism to a second right-angle surface of the prism, and reflected by the second right-angle surface of the prism.

In a possible implementation, if the first drive component may generate a first drive signal A1 based on a received first control signal, and input the first drive signal A1 to the galvanometer, the galvanometer may be adjusted to be at a position A1 based on the first drive signal A1, a corresponding optical propagation path of a second light beam is a dashed line, and a corresponding delay amount is dt. If the first drive component may generate a first drive signal B1 based on the received first control signal, the galvanometer may be adjusted to be at a position B1 based on the first drive signal B1, a corresponding optical propagation path of the second light beam is a solid line, and a corresponding delay amount is dt′. In other words, the first drive component inputs different first drive signals to the galvanometer, so that the galvanometer may be adjusted to be located at different positions, and optical paths corresponding to the second light beam passing through the galvanometer at different positions are different. In other words, the optical path of the second light beam may be changed by changing the position of the galvanometer. It may be understood that an optical path (or a delay amount) of the second light beam passing through the first relative delay module is related to a position of the galvanometer. Specifically, there is a correspondence between the delay amount and the position of the galvanometer. For details, refer to related descriptions of the following initialization process. Details are not described herein again.

Structure 2: The optical path adjustment component includes a structure with a variable refractive index.

In a possible implementation, the structure with the variable refractive index may include but is not limited to an optoelectronic crystal, a thermo-optical crystal, and the like. The optoelectronic crystal may be, for example, an electro-optic modulator (EOM), and may adjust a refractive index of the EOM by using an electrical signal to change the optical path of the second light beam. The refractive index of the thermo-optical crystal can be adjusted by using a thermal signal or an electric temperature control manner.

FIG. 8b is another schematic diagram of a structure of a first relative delay module according to this application. The first relative delay module includes a first drive component and an optical path adjustment component, and the optical path adjustment component includes an optoelectronic crystal. The first drive component may input different first drive signals to the optoelectronic crystal, the optoelectronic crystal may be adjusted to different refractive indexes based on the first drive signal, and optical paths of the second light beam passing through optoelectronic crystals with different refractive indexes are different. It may be understood that an optical path of the second light beam passing through the first relative delay module is related to a refractive index of the optoelectronic crystal. Specifically, there is a correspondence between the optical path of the second light beam and the refractive index of the optoelectronic crystal. For details, refer to related descriptions of the initialization process. Details are not described herein again.

Structure 3: The optical path adjustment component includes a spiral line.

FIG. 8c is still another schematic diagram of a structure of a first relative delay module according to this application. The first relative delay module includes a first drive component and an optical path adjustment component. The optical path adjustment component includes a spiral line, and a connection line between any point and a center on the spiral line is perpendicular to a tangent line of an arc at the any point. The first drive component inputs a first drive signal to the center of the spiral line. The spiral line may rotate around the center. In this case, a radius of the spiral line gradually increases. After a second light beam is reflected by the spiral line, an optical path also increases, and both an incident direction and an emergent direction of the second light beam remain unchanged. The correspondence between the optical path of the second light beam and the radius of the spiral line may be obtained in an initialization process. For details, refer to the initialization process. Details are not described herein again.

It should be noted that the foregoing three types of optical path adjustment components are merely examples. Any structure that can implement an optical path of a received light beam (for example, the second light beam or the first light beam) falls within the protection scope of this application. For example, the optical path of the received second light beam may also be a dual reflector (a first reflector and a second reflector) and a lens (refer to FIG. 8d). A reflection angle of at least one of the dual reflector may be changed, so that the optical path of the received second light beam may be changed.

It should be noted that a range of a delay amount that can be adjusted and controlled by the first relative delay module is greater than millimeters, and precision is less than micrometers, so that precise alignment and full coverage of ions trapped by the trapping module can be implemented. For example, the precision of the delay amount may be controlled on a femtosecond order, and precision of a space distance corresponding to the delay amount may be controlled on a micrometer order. In addition, a plurality of ions may share one first relative delay module.

In this application, the ion trap system may further include a first optical path module and a second optical path module. Further, the apparatus may further include a control module. Details are illustrated as follows.

It should be noted that the first optical path module may correspond to the first relative delay module, and the second optical path module does not correspond to the first relative delay module. Alternatively, the first optical path module does not correspond to the first relative delay module, and the second optical path module corresponds to the first relative delay module. Alternatively, the first optical path module corresponds to the first relative delay module, and the second optical path module also corresponds to the first relative delay module. It should be understood that, that the first optical path module corresponds to the first relative delay module may be understood as that the first light beam needs to pass through the first optical path module and the first relative delay module. That the first optical path module does not correspond to the first relative delay module may be understood as that the first light beam needs to pass through only the first optical path module and does not need to pass through the first relative delay module. The understanding that the second optical path module corresponds to or does not correspond to the first relative delay module is the same as that the first optical path module corresponds to or does not correspond to the first relative delay module. It may also be understood that, in optical propagation paths of the first light beam and the second light beam of manipulation ions, at least one light beam needs to pass through the first relative delay module.

In the following description, for ease of solution description, an example in which the second optical path module corresponds to the first relative delay module, the first optical path module does not correspond to the first relative delay module, and the first light beam passes through the first optical path module and the second light beam passes through the second optical path module is used for description.

### 5. First Optical Path Module and Second Optical Path Module

In a possible implementation, the first optical path module includes a first modulation component, and the first modulation component is configured to modulate a time sequence and/or a frequency (or a phase) of the first light beam. Specifically, a time sequence of the first light beam may be controlled by using an optical switch. That is, control of the time sequence of the first light beam is represented as switch switching in a time dimension. It may be understood that the first modulation component may modulate one first light beam (corresponding to one ion), or may modulate a plurality of first light beams (corresponding to a plurality of ions).

For example, the first modulation component may include but is not limited to an acoustic-optic modulator (AOM), and the AOM includes an acoustic-optic medium and a piezoelectric transducer. When a wave frequency of a specific carrier of a radio frequency driver drives the transducer, the transducer generates ultrasonic waves of the same frequency and transmits the ultrasonic waves to an acoustic-optic medium. A refractive index changes in the medium. When the light beams pass through the medium, the light beams interact with each other to change the propagation direction of the light beams, that is, diffractive light is emitted from the AOM.

Further, optionally, the first modulation component may include at least one or a combination of a single-channel modulator or a multi-channel modulator.

In a possible implementation, the first modulation component may be controlled by a radio frequency driver, and the radio frequency driver may be controlled by a radio frequency (RF) source. Further, the RF source may control, by using a radio frequency modulator, a time sequence and a frequency of a radio frequency signal input to the first modulation component, and the RF source may be controlled by using the control module. For details, refer to the following description of case 2. It should be noted that a time sequence and a frequency of the first light beam are related to a requirement of quantum computing. It may also be understood that, based on a requirement of a quantum algorithm, which ions need to be manipulated at which moments may be determined, to control a time sequence of the radio frequency signal. Further, optionally, the first optical path module may further include a first polarization component, and the first polarization component is configured to change a polarization state of the received first light beam. For example, the received first light beam is P-polarized light, and the first polarization component may convert a polarization state of the first light beam into left hand circularly polarized light. For another example, the received first light beam is S-polarized light, and the first polarization component may convert a polarization state of the first light beam into right hand circularly polarized light.

For example, the first polarization component may be, for example, a polarizer, a polarizer controller, or a Glan prism.

Further, optionally, the first optical path module may further include a first scaling and/or shaping component, where the first scaling and/or shaping component is configured to scale and/or shape the first light beam obtained after polarization state conversion. It should be understood that an electrode that traps the ion occupies large space near the ion, and a size of a light spot may be restricted by using a light transmission aperture. To prevent scattering of a light beam around, a size of a light spot of the first light beam usually needs to be restricted in space. If the light spot of the first light beam is large, the first optical path module may not include the first scaling and/or shaping component.

It may be understood that the first scaling and/or shaping component and the first polarization component are passive devices, and the first modulation component is an active device.

In a possible implementation, components included in the second optical path module may be the same as components included in the first optical path module, or components included in the second optical path module may be more than components included in the first optical path module, or components included in the second optical path module may be less than components included in the first optical path module. This is not limited in this application. Specifically, “first” in the first optical path module may be replaced with “second”.

It should be noted that the second modulation component included in the second optical path module is configured to change a polarization state of a received second light beam. If the first polarization component converts the polarization state of the first light beam into the left hand circularly polarized light, the second polarization component may convert the polarization state of the second light beam into the right hand circularly polarized light. If the first polarization component converts the polarization state of the first light beam into the right hand circularly polarized light, the second polarization component may convert the polarization state of the second light beam into the left hand circularly polarized light. Because polarization states of the first light beam and the second light beam affect coupling strength of the first light beam and the second light beam, and further affect quantum efficiency of manipulation of the ion, when a first light beam whose polarization state is right hand circularly polarized light and a second light beam whose polarization state is left hand circularly polarized light (or a first light beam whose polarization state is left hand circularly polarized light and a second light beam whose polarization state is right hand circularly polarized light) simultaneously reach a target ion, quantum efficiency of the ion is improved.

### 6. Control Module

In a possible implementation, the control module may control a delay amount for the first light beam and the second light beam to reach the first target ion. Further, the control module is further configured to control a time sequence and/or a frequency of the first light beam and the second light beam, to implement optical frequency locking. The following describes the cases.

Case 1: The control module is configured to control the first drive component.

In a possible implementation, the control module controls the first drive component to drive the first relative delay module by using the first drive component, to control the delay amount for the first light beam and the second light beam to reach the first target ion.

In the following description, an example in which the optical path adjustment component in the first relative delay module includes the galvanometer and the reflection element is used for description, and an example in which the second light beam passes through the first relative delay module is used for description.

In a possible implementation, the control module may generate the first control signal based on a correspondence between the position of the first target ion that needs to be manipulated and the first drive signal (for example, by referring to Table 1). Specifically, the control module may determine, based on the position of the first target ion, the delay amount for the first light beam and the second light beam to reach the first target ion, determine an optical path change amount of the second light beam based on the delay amount, determine a target position of the galvanometer based on the optical path change amount of the second light beam, determine parameter information of the first drive component based on the target location, and generate the first control signal based on the parameter information of the first drive component. Further, the control module sends a first control signal to the first drive component. The first control signal is used to control the first drive component to output a first drive signal, and the first control signal may include, for example, the parameter information of the first drive component. If the first drive component is a voltage source, the parameter information of the first drive component may include a voltage. If the first drive component is a current source, the parameter information of the first drive component may include a current. Further, the parameter information of the first drive component may further include a time sequence and the like. The first drive signal may be, for example, a signal required for moving the galvanometer to the target position.

TABLE 1
Correspondence between a position of an ion and
parameter information of a first drive component

| Ion | | Parameter information |
|---|---|---|
| identification | Position | of a first drive component |
| Ion A | Position 1 | I_{A} (or U_{A}) |
| Ion B | Position 2 | I_{B} (or U_{B}) |
| . . . | . . . | . . . |
| Ion N | Position N | I_{N} (or U_{N}) |

According to Table 1, if the ion A needs to be manipulated, a current that needs to be input by the control module to the first drive component is IA, or a voltage that needs to be input is UA. In this case, the first drive component may drive the first relative delay module to change the delay amount for the first light beam and the second light beam to reach the first target ion, so that the first light beam and the second light beam overlap at the ion A. In other words, the first light beam and the second light beam simultaneously reach the ion A. If the ion B needs to be manipulated, a current that needs to be input by the control module to the first drive component is I_{B}, or a voltage that needs to be input is U_{B}. In this case, the first drive component drives the first relative delay module to change the delay amount between the first light beam and the second light beam, so that the first light beam and the second light beam overlap at the ion B. In other words, the first light beam and the second light beam simultaneously reach the ion B. Details are not listed herein.

It should be noted that Table 1 may be obtained and stored in the ion trap initialization process. Table 1 needs to be dynamically updated or calibrated when the position of the ion in the trapping module moves.

Case 2: The control module controls the radio frequency source.

In a possible implementation, the control module is further configured to control a parameter and a time sequence of the radio frequency source, to control a time sequence and/or a frequency of the first light beam and the second light beam. Specifically, the control module may control the RF source to input a control signal 1 to the first radio frequency driver, to control the time sequence and/or the frequency of the first light beam based on a requirement of quantum computing; and/or the control module may control the RF source to input a control signal 2 to the second radio frequency driver, to control the time sequence and/or the frequency of the second light beam based on a requirement of quantum computing.

For example, the control module may include, for example, one or more processing units. The processing unit may be, for example, a field programmable gate array (FPGA), a proportional-integral-differential (PID) controller, an application processor (AP), a graphics processing unit (GPU), an image signal processor (ISP), a controller, a digital signal processor (DSP), an application specific integrated circuit (ASIC), a central processing unit (CPU), or another programmable logic device, a transistor logic device, a hardware component, or any combination thereof. Different processing units may be independent components, or may be integrated into one or more processors.

After quantum state manipulation is completed, quantum state detection may be further performed on the ion. Based on this, the ion trap system may further include a detection module. Detection light is illuminated on a corresponding ion, and the ion generates photoluminescence, thereby generating fluorescence. The detection module may obtain quantum state information of the ion by collecting the fluorescence generated by the ion. For example, the fluorescence may represent whether a quantum state of an ion is a 0 state or a 1 state. Further, the detection module may send the read quantum state information of the ion to the control module, so that the control module re-regulates and controls the first drive component and/or the radio frequency source. For details, refer to the description of the control module.

For example, the detection module may be, for example, an avalanche photodiode (APD), a photomultiplier (PMT), an electron multiplying charge coupled device (EMCCD), a four-quadrant photoelectric detector, or a complementary metal-oxide semiconductor (CMOS) detector.

Further, as time moves, the positions of the trapped ion in the trapping module may change. To implement accurate addressing of the first light beam and the second light beam to corresponding ions, parameters of some or all modules in the ion trap system further need to be dynamically adjusted. Based on this, the ion trap system may further include a feedback module. Input of the feedback module is the quantum state information of the ion, and output is the voltage or the current of the first relative delay module. The feedback module is mainly used for alignment debugging, and may implement alignment maintenance. It should be understood that the quantum state information of the ion may be obtained by detecting the detection light. Further, the feedback module may further reduce or even eliminate impact caused by mechanical drift, so that the first light beam and the second light beam can be aligned with the ion for a long time, thereby implementing long-time manipulation.

It should be noted that the function of the control module and the function of the feedback module may be integrated into one piece of hardware, or may be integrated into different pieces of hardware. This is not limited in this application.

The following example shows the initialization process of the ion trap.

First, the trapped ion in the trapping module is initialized to a quantum initial state, for example, a 0 state. Then, the detection module detects the quantum state information of the ion, and adjusts the delay amount based on the quantum state information of the ion, to determine the position of the ion to be addressed. Specifically, when the control module cannot obtain the quantum state information of the ions, it indicates that the first light beam and the second light beam do not reach any ions at the same time, that is, no ion is illuminated, and the delay amount continues to be adjusted. When quantum state information of an ion is obtained, that is, the first light beam and the second light beam reach the ion at the same time, that is, the ion is illuminated, a relationship diagram between a Rabi intensity and positions of the first light beam and the second light beam may be obtained by continuously changing propagation directions of the first light beam and the second light beam and scanning the corresponding ions by using Rabi oscillation. When the positions of the first light beam and the second light beam are completely aligned with the corresponding ions, the measured Rabi intensity £2 is the largest. In this case, the position of the ion, a corresponding delay amount, an initial propagation direction of the first light beam, and an initial propagation direction of the second light beam are recorded. After the initial propagation directions of the first light beam and the second light beam are determined, the propagation directions of the first light beam and the second light beam are not changed subsequently, and different ions are addressed only by adjusting the delay amount. If the obtained quantum state information of the ion is not an ion that needs to be addressed, the delay amount is continuously adjusted, and after a specific ion is illuminated, a correspondence between a position of the specific ion and a delay amount is recorded.

For example, after quantum state information of the ion A is obtained, a correspondence between a position of the ion A and a delay amount A is recorded based on the foregoing same method; when quantum state information of the ion B is obtained, a correspondence between a position of the ion B and a delay amount B is recorded; and so on. When an ion E needs to be addressed, but quantum state information of an ion C is obtained again, the delay amount may continue to be adjusted until the quantum state information of the ion E is obtained, and then a correspondence between a position of the ion E and a delay amount E is recorded.

TABLE 2
Correspondence between an ion
position and a delay amount

| Ion | Delay amount |
|---|---|
| Ion A | ΔA |
| Ion B | ΔB |
| . . . | . . . |
| Ion E | ΔE |

Further, optionally, in the initialization process of the ion trap, a value of a parameter that needs to be changed by the optical path adjustment component when a corresponding delay amount is met may be further determined. If the optical path adjustment component includes a galvanometer and a reflection element, a target position of a corresponding galvanometer that needs to meet each delay amount in Table 2 may be further determined. If the optical path adjustment component includes a structure with a variable refractive index, a target refractive index of a structure with a variable refractive index corresponding to each delay amount in Table 2 may be further determined. Details are not listed herein one by one.

Table 3 shows a relationship between the delay amount and a position of the galvanometer by using an example in which the optical path adjustment component includes the galvanometer and the reflection element.

TABLE 3
Correspondence between a delay amount
and a position of a galvanometer

| Delay | Position of a |
|---|---|
| amount | galvanometer |
| ΔA | Position A |
| ΔB | Position B |
| . . . | . . . |
| ΔE | Position E |

Further, in the initialization process of the ion trap system, parameter information sent by the control module to the first drive component when the galvanometer is to move to a corresponding target position may be further determined. For details, refer to Table 1.

It should be noted that, after the initialization of the ion trap system is completed, Table 2 to Table 3 may be separately stored, or Table 2 to Table 3 may be combined into Table 1 for storage. This is not limited in this application.

It may be understood that, the initialization process of the ion trap may be iterative automatic calibration and adjustment performed by using a software program.

Based on the foregoing content, the following provides five specific possible implementations of the foregoing ion trap system. This helps to further understand the architecture of the ion trap system and the ion addressing process. It should be noted that, in the foregoing modules, if no special description or logic conflict is provided, another possible ion trap system may be formed based on the internal logical relationship of the modules. The following four ion trap systems are merely examples.

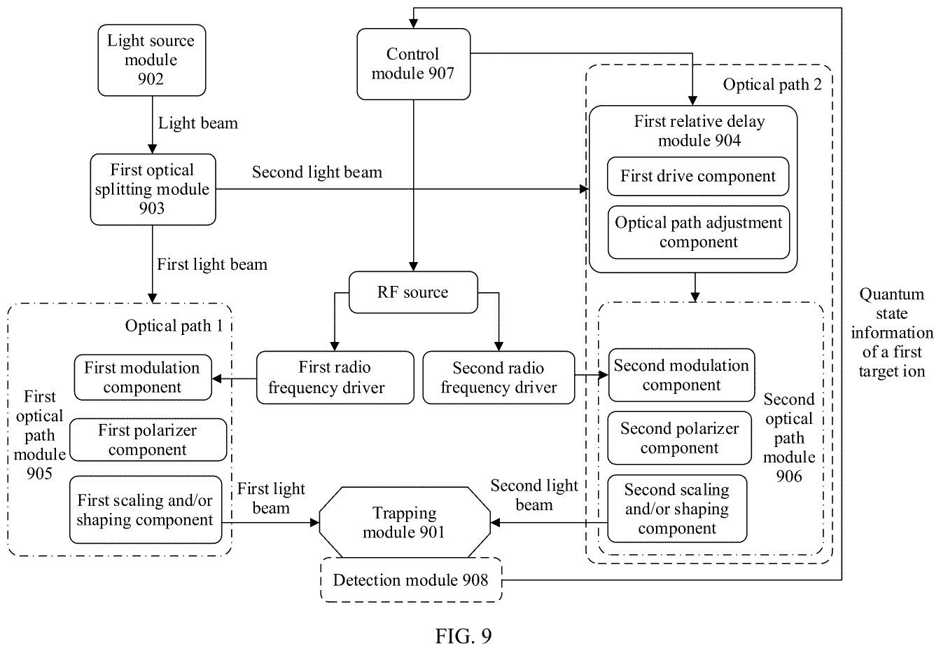

FIG. 9 is another schematic diagram of an architecture of an ion trap system according to this application. The ion trap system may include a trapping module 901, a light source module 902, a first optical splitting module 903, a first relative delay module 904, a first optical path module 905, and a second optical path module 906. Further, optionally, the ion trap system may further include a control module 907 and a detection module 908. In this example, that the second optical path module 906 corresponds to the first relative delay module 904 is used as an example, and that a first light beam passes through an optical path 1 and a second light beam passes through an optical path 2 is used as an example. For detailed descriptions of the modules, refer to the foregoing related content. Details are not described herein again.

An optical propagation path based on the ion trap system shown in FIG. 9 is: The light source module 902 transmits a light beam based on a first pulse, and the light beam is split into the first light beam and the second light beam through the first optical splitting module 903. An optical path through which the first light beam passes may be referred to as the optical path 1. Specifically, the first light beam is propagated to a first target ion through the first optical path module 905. An optical path through which the second light beam passes may be referred to as the optical path 2. Specifically, the second light beam is propagated to the second optical path module 906 through the first relative delay module 904. The optical path of the second light beam may be changed by using the first relative delay module 904, so that a delay amount for the first light beam and the second light beam to reach the first target ion may be changed. Then the second light beam is propagated to the first target ion through the second optical path module 906. Based on this, the first light beam and the second light beam simultaneously reach the first target ion, to implement addressing of the first target ion. To improve quantum efficiency, the first light beam reaching the first target ion is left hand circularly polarized light, and the second light beam reaching the first target ion is right hand circularly polarized light. Alternatively, the first light beam reaching the first target ion is right hand circularly polarized light, and the second light beam reaching the first target ion is left hand circularly polarized light. Further, after the first light beam and the second light beam manipulate the first target ion, the detection module 908 may further detect quantum state information of the first target ion. For details, refer to the foregoing description of the detection module. Details are not described herein again.

It may be understood that, based on the ion trap system shown in FIG. 9, independent addressing of a single ion may be implemented, or entangled addressing of two or more ions may be implemented. Specifically, this is related to a first pulse width of the light beam transmitted by the light source module. If the first space distance corresponding to the first pulse width is less than a spacing between any two adjacent ions, addressing of a single ion may be implemented. If the first space distance corresponding to the first pulse width is greater than the spacing between two adjacent ions, entanglement addressing of two or more ions may be implemented.

Based on the foregoing ion trap system, adjusting, by using the first relative delay module, the delay amount for the first light beam and the second light beam to reach the first target ion may also be understood as: controlling, by using the first relative delay module, photon flight time, so that the first light beam and the second light beam can be accurately controlled to overlap at different ions, thereby implementing high-precision independent addressing for different ions.

It should be noted that sequences of components included in the first optical path module 905 in FIG. 9 may be exchanged, and sequences of components included in the second optical path module 906 may also be exchanged. In addition, locations of the second optical path module 906 and the first relative delay module 904 may be exchanged. The architecture shown in FIG. 9 is merely a possible example.

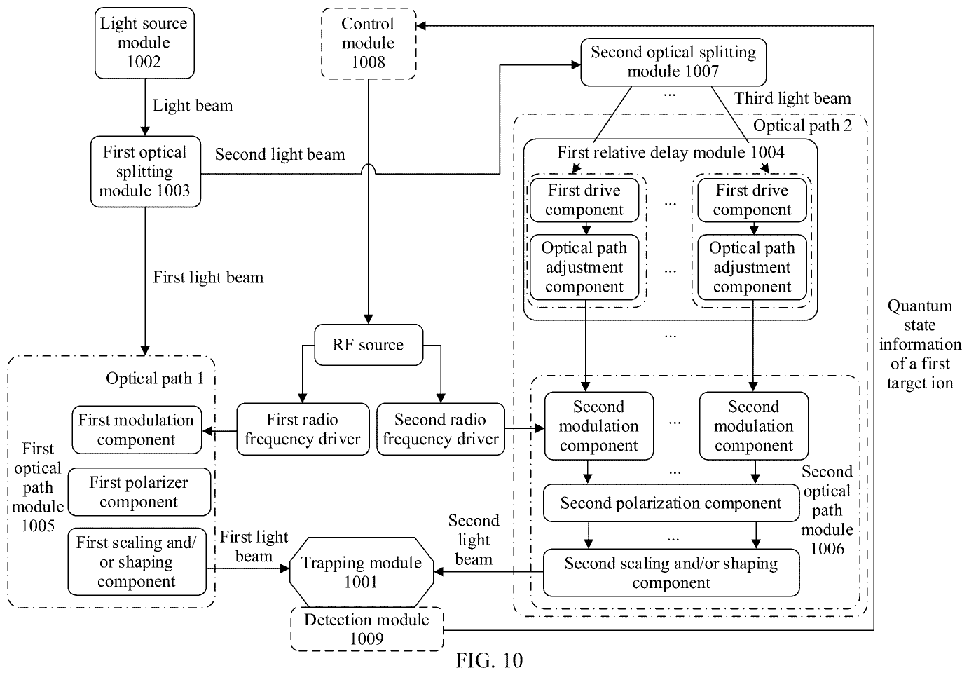

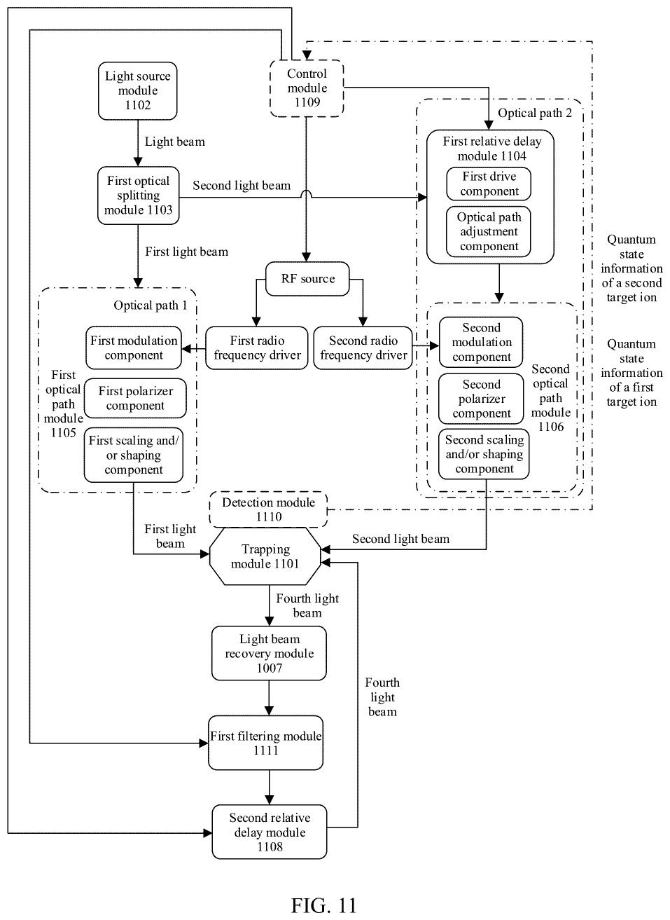

FIG. 10 is another schematic diagram of an architecture of an ion trap system according to this application. The ion trap system may include a trapping module 1001, a light source module 1002, a first optical splitting module 1003, a first relative delay module 1004, a first optical path module 1005, a second optical path module 1006, and a second optical splitting module 1007. Further, optionally, the ion trap system may further include a control module 1008 and a detection module 1009. In this example, that the second optical path module 1006 corresponds to the first relative delay module 1004 is used as an example, and that a first light beam passes through an optical path 1 and a second light beam passes through an optical path 2 is used as an example. The first relative delay module 1004 includes N relative delay submodules. A second modulation component included in the second optical splitting module 1007 may be a modulator including at least N channels, and one relative delay submodule 1004 corresponds to one channel. Alternatively, the second modulation component may be N modulators, and one relative delay submodule 1004 corresponds to one modulator.

Alternatively, the second modulation component may be a modulator including m single channels and a modulator including N-m channels, and one relative delay submodule 1004 corresponds to one channel or one single-channel modulator. FIG. 10 is an example in which one relative delay submodule 1004 corresponds to one modulator. The second optical splitting module 1007 is configured to split the second light beam that is from the first optical splitting module into N third light beams, where one third light beam corresponds to one relative delay submodule 1004. For the second optical splitting module 1007, refer to the foregoing description of the first optical splitting module. A difference between the second optical splitting module 1007 and the first optical splitting module lies in that a quantity of light beams split by the second optical splitting module 1007 may be different from that of the first optical splitting module 1003. For related descriptions of the trapping module 1001, the light source module 1002, the first optical splitting module 1003, the first relative delay module 1004, the first optical path module 1005, the second optical path module 1006, the second optical splitting module 1007, the control module 1008, and the detection module 1009, refer to the foregoing related descriptions. Details are not described herein again.

An optical propagation path based on the ion trap system shown in FIG. 10 is: After the light source module 1002 transmits a light beam based on a first pulse width, the light beam is split into a first light beam and a second light beam through the first optical splitting module 1003. An optical path through which the first light beam passes may be referred to as the optical path 1. Specifically, the first light beam is propagated to a first target ion through the first optical path module 1005. An optical path through which the second light beam passes may be referred to as the optical path 2. Specifically, the second light beam is split into N third light beams by the second optical splitting module 1007, each third light beam is propagated to a corresponding second modulation component in the second optical path module 1006 through a corresponding relative delay submodule 1004, and an optical path of the second light beam may be changed by using the corresponding relative delay submodule, so that the delay amount for the first light beam and the second light beam to reach the first target ion may be changed. Then the second light beam is propagated to the first target ion through the second optical path module 1006. Based on this, the N third light beams respectively overlap with the first light beam at different ions, so that addressing can be performed on a plurality of ions. In addition, during quantum computing, parallel multi-quantum-bit calculation may be performed, and more quantum algorithms may be applied based on the ion trap system.

Further, after the first light beam and the third light beam manipulate the first target ion, the detection module 1009 may further detect quantum state information of the first target ion. For details, refer to the foregoing description of the detection module. Details are not described herein again.

It should be noted that a polarization state of the third light beam is the same as a polarization state of the second light beam. Therefore, to improve quantum efficiency, the first light beam reaching the first target ion is left hand circularly polarized light, and the third light beam reaching the first target ion is right hand circularly polarized light. Alternatively, the first light beam reaching the first target ion is right hand circularly polarized light, and the third light beam reaching the first target ion is left hand circularly polarized light.

It should be noted that sequences of components included in the first optical path module 1005 in FIG. 10 may be exchanged, and sequences of components included in the second optical path module 1006 may also be exchanged. In addition, locations of the second optical path module 1006 and the first relative delay module 1004 may be exchanged. The sequence shown in FIG. 10 is merely a possible example.

FIG. 11 is another schematic diagram of an architecture of an ion trap system according to this application. The ion trap system may include a trapping module 1101, a light source module 1102, a first optical splitting module 1103, a first relative delay module 1104, a first optical path module 1105, a second optical path module 1106, a first light beam recovery module 1107, and a second relative delay module 1108. Further, optionally, the ion trap system may further include a control module 1109 and a detection module 1110. Further, optionally, the ion trap system may further include a first filtering module 1111. In this example, that the first relative delay module 1104 corresponds to the second optical path module 1106 is used as an example. For the trapping module 1101, the light source module 1102, the first optical splitting module 1103, the first relative delay module 1104, the first optical path module 1105, the second optical path module 1106, the control module 1109, and the detection module 1110, refer to the foregoing related descriptions. Details are not described herein again.

The first light beam recovery module 1107 may be configured to recover a fourth light beam, where the fourth light beam is remaining light of the first light beam after the first target ion is manipulated or remaining light of the second light beam after the first target ion is manipulated. In FIG. 11, an example in which the fourth light beam is the remaining light of the second light beam is used. For example, the first light beam recovery module 1107 may include but is not limited to a reflector, a diffraction grating, a polarizing beam splitter, or the like.

The second relative delay module 1108 is configured to adjust a delay amount for the fourth light beam and the first light beam to reach the second target ion, where an adjusted fourth light beam and the first light beam overlap at the second target ion. The second target ion in an ion other than the first target ion in the at least two ions. For a structure of the second relative delay module 1108, refer to the foregoing description of the first relative delay module. A difference lies in that the first relative delay module adjusts the optical path of the second light beam, and the second relative delay module adjusts the optical path of the fourth light beam. The optical path of the fourth light beam is equal to a sum of k times a second space distance corresponding to a time interval at which the light source module transmits two adjacent light beams and two times a distance between the first target ion and the second target ion, where k is a positive integer. Specifically, L₄=k×DL+2×Δ₁₂=k×C×Dt+2×Δ₁₂, where Δ₁₂ represents a spacing between the first target ion and the second target ion.

In a possible application scenario, if the ions trapped by the trapping module are ions distributed at equal intervals in one dimension, the optical path of the fourth light beam is equal to a sum of k times the second space distance and m times the spacing Δ between the two adjacent ions, where both k and m are positive integers. Specifically, L₄=k×DL+2 mΔ=k×C×Dt+2 mΔ. For example, if the first light beam and the second light beam in the initial state manipulate the first ion, when m=1 and k=1, the first light beam and the fourth light beam may address the second ion; when m=2 and k=1, the first light beam and the fourth light beam may address the third ion; and so on. It may also be understood that an order of addressing ions (or referred to as an arrangement and combination manner of the addressed ions) may be implemented by controlling a value of m.

The first filtering module 1111 is configured to: allow a received fourth light beam to pass through in a first time domain, and propagate the fourth light beam to the second relative delay module 1108. It may also be understood that the first filtering module is mainly configured to perform wave selection in first time domain, or is referred to as filtering. For example, the first filtering module may be a filter (or referred to as a wave selector), and the filter may have at least two states: a closed (or transferred) state and a pass-through state. In the first time domain, if the filter is in the pass-through state, it indicates that the filter allows the fourth light beam to pass through in the first time domain; or in time domain other than the first time domain, if the filter is in the closed state, it indicates that the fourth light beam is not allowed to pass through in the time domain other than the first time domain. In other words, when the filter is set to the pass-through state, the fourth light beam may be allowed to pass through. When the filter is set to the closed state, the fourth light beam cannot pass through, or the fourth light beam is transferred to a garbage bin (or referred to as a light collection bin).

An optical propagation path based on the ion trap system shown in FIG. 11 is: The light source module 1102 transmits a light beam based on a first pulse width, and the light beam is split into the first light beam and the second light beam through the first optical splitting module 1103. An optical path through which the first light beam passes may be referred to as the optical path 1. Specifically, the first light beam is propagated to a first target ion through the first optical path module 1105. An optical path through which the second light beam passes may be referred to as the optical path 2. Specifically, the second light beam is propagated to the second optical path module 1106 through the first relative delay module 1104. The optical path of the second light beam may be changed by using the first relative delay module 1104, so that a delay amount for the first light beam and the second light beam to reach the first target ion may be changed. Then the second light beam is propagated to the first target ion through the second optical path module 1106. Based on this, after the first light beam and the second light beam simultaneously reach the first target ion, addressing of the first target ion is implemented. Further, remaining light (which may be referred to as the fourth light beam) after the second light beam manipulates the first target ion is recovered by the first light beam recovery module 1107 and propagated to the first filtering module 1111. The first filtering module 1111 allows the fourth light beam to pass through and propagate the fourth light beam to the second relative delay module 1108 in the first time domain. After the second relative delay module 1108 adjusts an optical path, the fourth light beam propagates to the second target ion. In this case, the first light beam also continues to propagate forward in a propagation direction, and overlaps with the fourth light beam at the second target ion. It should be noted that the first light beam that overlaps with the fourth light beam and the first light beam that overlaps with the second light beam are not first light beams split from a same light beam transmitted by the light source module, and may be first light beams split from two of a plurality of light beams transmitted by the light source module. For example, the light source module sequentially transmits a light beam A, a light beam B, and a light beam C. The light beam A is split into a first light beam A1 and a second light beam A2 through the first optical splitting module, the light beam B is split into a first light beam B1 and a second light beam B2 through the first optical splitting module, and the light beam C is split into a first light beam C1 and a second light beam C2 through the first optical splitting module. The first light beam that is overlapped with the fourth light beam may be the first light beam C1, and the first light beam that is overlapped with the second light beam A2 is the first light beam A1

Further, after the first light beam and the second light beam manipulate the first target ion, the detection module 1110 may further detect quantum state information of the first target ion. After the first light beam and the fourth light beam manipulate the second target ion, the detection module 1110 may further detect quantum state information of the second target ion.

It should be noted that a first light beam recovery module and a third relative delay module may be further disposed in the ion trap system shown in FIG. 11. The first light beam recovery module may be configured to recover remaining light (which may be referred to as a fifth light beam) after the first light beam manipulates the first target ion. The third relative delay module may change an optical path of the fifth light beam, to adjust a delay amount for the fifth light beam and the fourth light beam to reach the second target ion. It may also be understood that the optical path of the fifth light beam may be changed by using the third relative delay module, and the optical path of the fourth light beam may be changed by using the second relative delay module. In other words, the delay amount for the fourth light beam and the fifth light beam to reach the second target ion are changed by using the third relative delay module and the second relative delay module together.

It should be noted that sequences of components included in the first optical path module 1105 in FIG. 11 may be exchanged, and sequences of components included in the second optical path module 1106 may also be exchanged. In addition, locations of the second optical path module 1106 and the first relative delay module 1104 may be exchanged, and locations of the second relative delay module 1108 and the first filtering module 1111 may also be exchanged. The architecture shown in FIG. 11 is merely a possible example.

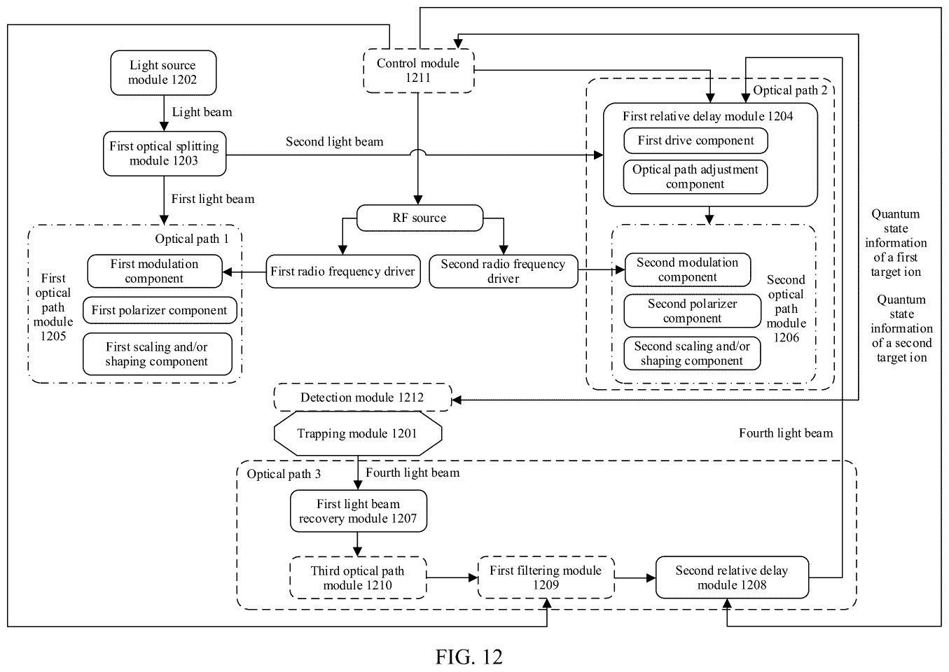

FIG. 12 is another schematic diagram of an architecture of an ion trap system according to this application. The ion trap system may include a trapping module 1201, a light source module 1202, a first optical splitting module 1203, a first relative delay module 1204, a first optical path module 1205, a second optical path module 1206, a first light beam recovery module 1207, and a second relative delay module 1208. Further, optionally, the ion trap system may further include a first filtering module 1209 and a third optical path module 1210. Further, optionally, the ion trap system may further include a control module 1211 and a detection module 1212. In this example, the first relative delay module 1204 corresponds to the second optical path module 1206. For the trapping module 1201, the light source module 1202, the first optical splitting module 1203, the first relative delay module 1204, the first optical path module 1205, the second optical path module 1206, the control module 1211, and the detection module 1212, refer to the foregoing related descriptions. Details are not described herein again. For the first light beam recovery module 1207, the second relative delay module 1208, and the first filtering module 1209, refer to related descriptions in FIG. 11. Details are not described herein again.

Compared with the first optical path module, the third optical path module 1210 does not have a first modulation component, and compared with the second optical path module, the third optical path module 1210 does not have a second modulation component. It may also be understood that the third optical path module 1210 may include a third scaling and/or shaping component, and may further include a third polarizer. For the third scaling and/or shaping component, refer to the description of the first scaling and/or shaping component. For the third polarizer, refer to the description of the first polarizer. To maximize quantum efficiency, a polarization state of the fourth light beam is the same as a polarization state of the second light beam. Therefore, if the third optical path module 1210 includes the third polarizer, a polarization state that is allowed to pass through by the third polarization state is the same as a polarization state that is allowed to pass through by the second polarizer.

An optical propagation path based on the ion trap system shown in FIG. 12 is: The light source module 1202 transmits a light beam based on a first pulse width, and the light beam is split into the first light beam and the second light beam through the first optical splitting module 1203. An optical path through which the first light beam passes may be referred to as the optical path 1. Specifically, the first light beam is propagated to a first target ion through the first optical path module 1205. An optical path through which the second light beam passes may be referred to as the optical path 2. Specifically, the second light beam is propagated to the second optical path module 1206 through the second relative delay module 1208. The optical path of the second light beam may be changed by using the first relative delay module 1204, so that a delay amount for the first light beam and the second light beam to reach the first target ion may be changed. Then the second light beam is propagated to the first target ion through the second optical path module 1206. Based on this, after the first light beam and the second light beam simultaneously reach the first target ion, addressing of the first target ion is implemented. Further, remaining light (which may be referred to as the fourth light beam) after the second light beam manipulates the first target ion is recovered and propagated by the first light beam recovery module 1207 to the third optical path module 1210, and propagated to the first filtering module 1209 through the third optical path module 1210. The first filtering module 1209 allows the fourth light beam to pass through in a first time domain, propagates the fourth light beam to the second relative delay module 1208, and changes the optical path of the fourth light beam by using the second relative delay module 1208. The fourth light beam whose optical path is changed is propagated to the first relative delay module 1204 in the optical path 2, and the first relative delay module 1204 and the second relative delay module 1208 may adjust the delay amount for the fourth light beam and the first light beam to reach the second target ion. An optical path that the fourth light beam passes through before returning to the optical path may be referred to as an optical path 3.

It should be noted that sequences of components included in the first optical path module 1205 in FIG. 12 may be exchanged, and sequences of components included in the second optical path module 1206 may also be exchanged. In addition, locations of the second optical path module 1206 and the first relative delay module 1204 may be exchanged, and locations of the second relative delay module 1208, the first filtering module 1209, and the third optical path module 1210 may also be exchanged. The architecture shown in FIG. 12 is merely a possible example.

By using the ion trap system shown in FIG. 11 or FIG. 12, the optical path of the fourth light beam may be changed by using the second relative delay module, so that the delay amount for the fourth light beam and the first light beam to reach the second target ion may be adjusted, thereby implementing addressing of a plurality of ions in sequence. In addition, an arrangement and assembly manner of the addressed ions may be changed by adjusting the delay amount for the fourth light beam and the first light beam to reach the second target ion. For example, the arrangement and assembly manner of addressing may be a first ion, a second ion, a third ion, or the like, or may be a first ion, a third ion, a second ion, or the like. This is not listed herein one by one. Further, remaining energy of the first light beam or the second light beam after the ion is manipulated is recovered, which helps improve energy utilization, and in multi-ion simultaneous addressing, power consumption of the ion trap system and system complexity may be reduced.

The following further analyzes the beneficial effect provided above.

Using the ion trap system shown in FIG. 12 as an example, the optical path of the fourth light beam is L₄=k×DL+2×Δ₁₂=k×C×Dt+2×Δ₁₂. Based on this, a third space distance (for example, an order of several micrometers) corresponding to a delay amount (for example, an order of 10 fs) for the fourth light beam and the first light beam to reach the second target ion is equal to the spacing Δ₁₂ between the first target ion and the second target ion. Therefore, different fourth light beams and an opposite first light beam may overlap at the second target ion.

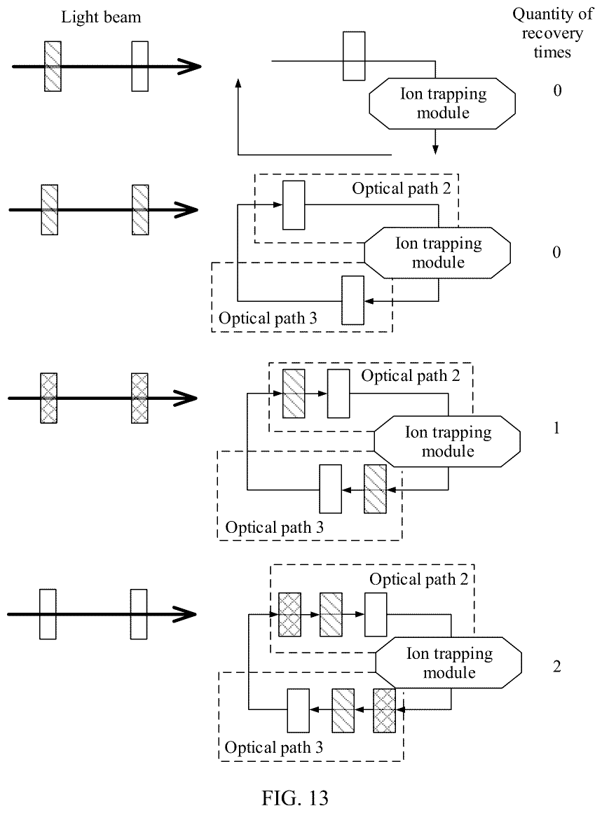

FIG. 13 is a schematic diagram of a pulse group formed by a recovered fourth light beam according to this application. For example, a light source module sequentially transmits a light beam A, a light beam B, a light beam C, a light beam D, a light beam E, a light beam F, and a light beam G. The light beam A is split into a first light beam A₁ and a second light beam A₂ through a first optical splitting module. The light beam B is split into a first light beam B₁ and a second light beam B₂ through the first optical splitting module. The light beam C is split into a first light beam C₁ and a second light beam C₂ through the first optical splitting module. The light beam D is split into a first light beam D₁ and a second light beam D₂ through the first optical splitting module. The light beam E is split into a first light beam E₁ and a second light beam E₂ through the first optical splitting module. The light beam F is split into a first light beam F₁ and a second light beam F₂ through the first optical splitting module. The light beam G is split into a first light beam G₁ and a second light beam G₂ through the first optical splitting module. After the first light beam A₁ and the second light beam A₂ manipulate a corresponding first target ion, a fourth light beam a may be recovered and obtained. After the first light beam B₁ and the second light beam B₂ manipulate the corresponding first target ion, a fourth light beam b may be recovered and obtained. After the first light beam C₁ and the second light beam C₂ manipulate the corresponding first target ion, a fourth light beam c may be recovered and obtained. Based on this, the fourth light beam a, the fourth light beam b, and the fourth light beam c have been recovered from an optical path. The fourth light beam a, the fourth light beam b, and the fourth light beam c may form a pulse sequence, which is equivalent to extending a single pulse into a pulse sequence. It should be noted that the fourth light beam may also be recovered and reused to form the pulse sequence.

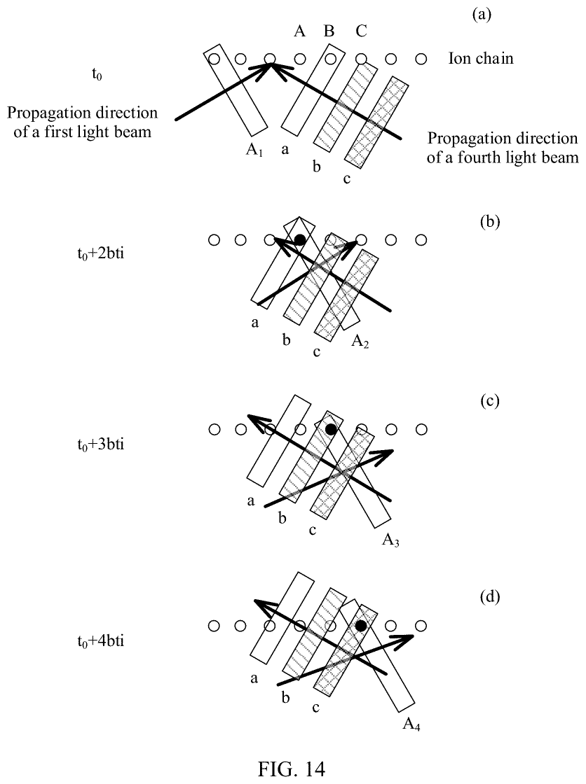

Based on the pulse sequence formed by the fourth light beam a, the fourth light beam b, and the fourth light beam c, the second relative delay module may control that the first light beam D₁ and the fourth light beam a may not overlap (refer to (a) in FIG. 14), the fourth light beam a may overlap with the first light beam E₁ at a second target ion A (refer to (b) in FIG. 14 below), the fourth light beam b may overlap with the first light beam F₁ at a second target ion B (refer to (c) in FIG. 14 below), and the fourth light beam c overlaps with the first light beam G₁ at a second target ion C (refer to (d) in FIG. 14 below). It may also be understood that, the second relative delay module may control a delay amount between the fourth light beam a and the first light beam E₁ to be dt3_1, a delay amount between the fourth light beam b and the first light beam F₁ to be dt3_2, and a delay amount between the fourth light beam c and the first light beam G₁ to be dt3_3. After the fourth light beam a, the fourth light beam b, and the fourth light beam c are combined, the presented delay amounts are pulse sequences of dt3_1, dt3_2, and dt3_3 respectively. Specifically, at a moment to, the fourth light beam a and the first light beam D₁ do not overlap at the ion, and no manipulation is performed on the ion. At a moment to +2*dti, the fourth light beam a and the first light beam E₁ overlap at the ion A. At a moment to +3*dti, the fourth light beam b and the first light beam F₁ overlap at the ion B. At a moment to +4*dti, the fourth light beam c and the first light beam G₁ overlap at the ion C.

By using the second relative delay module, the pulse sequence formed by the fourth light beam a, the fourth light beam b, and the fourth light beam c and the first light beam that is opposite to the fourth light beam a, the fourth light beam b, and the fourth light beam c may overlap at different ions, thereby implementing addressing of different ions. Because a time difference between manipulation of different ions is on a 10 fs order, a pulse interval of a pulse sequence formed by the fourth light beam a, the fourth light beam b, and the fourth light beam c is far less than a manipulation period of the manipulated ion. Therefore, it may be considered that the plurality of ions may be simultaneously addressed based on this.

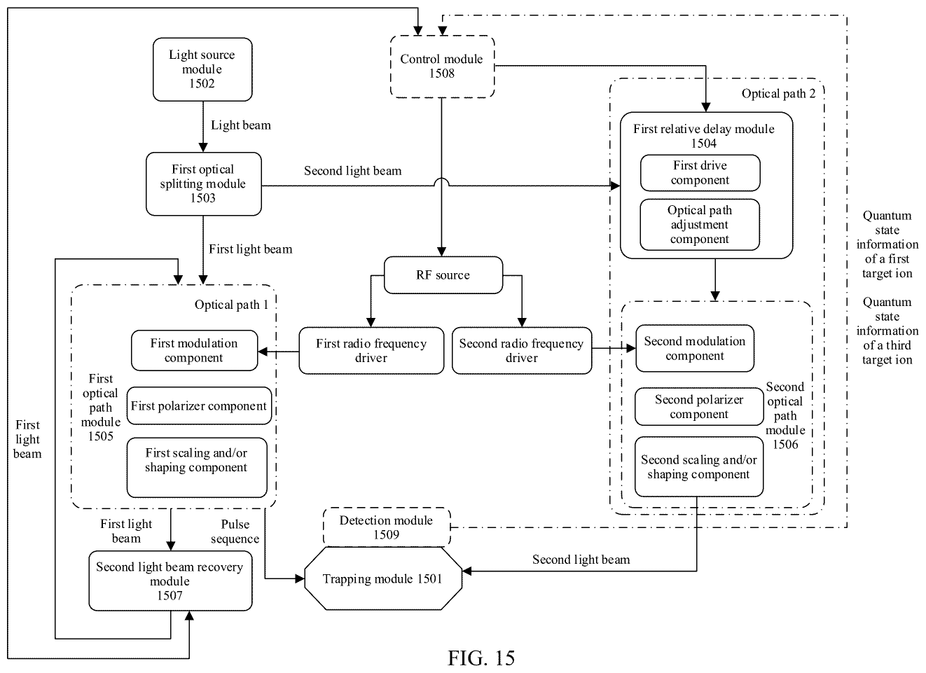

FIG. 15 is another schematic diagram of an architecture of an ion trap system according to this application. The ion trap system may include a trapping module 1501, a light source module 1502, a first optical splitting module 1503, a first relative delay module 1504, a first optical path module 1505, a second optical path module 1506, and a second light beam recovery module 1507. Further, optionally, the ion trap system may further include a control module 1508 and a detection module 1509. In this example, that the first relative delay module 1504 corresponds to the second optical path module 1506 is used as an example. For the trapping module 1501, the light source module 1502, the first optical splitting module 1503, the first relative delay module 1504, the first optical path module 1505, the second optical path module 1506, the control module 1508, and the detection module 1509, refer to the foregoing related descriptions. Details are not described herein again.

The second light beam recovery module 1507 is configured to return, in a second time domain, a first light beam from the first optical path module 1505 to the first optical path module 1505, to form a pulse sequence; and propagate, in a third time domain, the pulse sequence formed by the first light beam to the trapping module 1501. For example, the second light beam recovery module 1507 may include but is not limited to a reflector, a diffraction grating, a polarizing beam splitter, or the like.

In a possible implementation, the second time domain and the third time domain may be controlled by using the control module 1508. A pulse interval of a pulse sequence formed by the first light beam may be adjusted by using control of the second time domain. A pulse interval of a pulse sequence formed by the second light beam may be adjusted by using control of the third time domain.

An optical propagation path based on the ion trap system shown in FIG. 15 is as follows: After the light source module 1502 transmits a light beam based on a first pulse width, the light beam is split into a first light beam and a second light beam through the first optical splitting module 1503. An optical path through which the first light beam passes may be referred to as an optical path 1. Specifically, after being propagated by the first optical path module 1505, the first light beam is returned to the first optical path module 1505 by using the second light beam recovery module 1507, to form a pulse sequence. An optical path through which the second light beam passes may be referred to as the optical path 2. Specifically, the second light beam is propagated to the second optical path module 1506 through the first relative delay module 1504. The optical path of the second light beam may be changed by using the first relative delay module 1504, so that a delay amount for the first light beam and the second light beam to reach the first target ion may be changed. Then the second light beam is propagated to a third target ion through the second optical path module 1506. Based on this, when the pulse sequence formed by the first light beam and the second light beam reach the third target ion at the same time, addressing of the third target ion may be implemented. Further, after the first light beam and the second light beam manipulate the third target ion, the detection module 1509 may further detect quantum state information of the third target ion. For details, refer to the foregoing description of the detection module. Details are not described herein again. Based on this, the pulse sequences formed by the first light beam and the second light beam sequentially overlap at different ions, so that addressing can be performed on a plurality of ions. In addition, during quantum computing, parallel multi-quantum-bit calculation may be performed, and more quantum algorithms may be applied based on the ion trap system.

It should be noted that FIG. 15 is an example in which the first light beam is recovered to form the pulse sequence. The ion trap system may also recover the second light beam to the second optical path module 1506 to form a pulse sequence, to implement addressing for different ions. Specifically, the second light beam recovery module is configured to return, in a fourth time domain, the first light beam that is from the second optical path module to the second optical path module, where the second light beam that is returned to the second optical path module and the second light beam that is from the first optical splitting module form a pulse sequence.

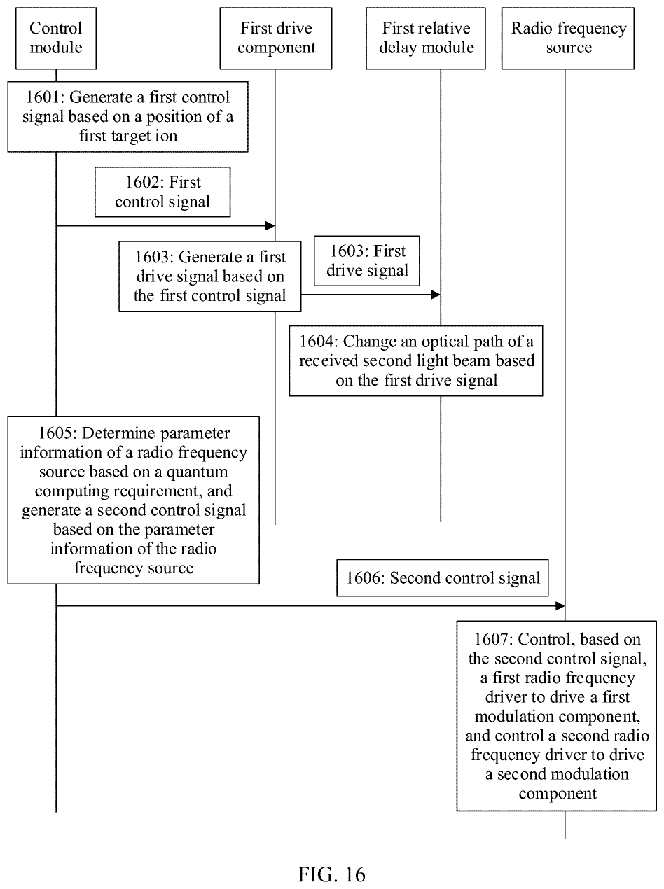

Based on the foregoing content and a same concept, this application provides an ion manipulation method. Refer to the description in FIG. 16. The ion manipulation method may be applied to the ion trap system shown in any one of the embodiments in FIG. 2 to FIG. 15. It may also be understood that the ion manipulation method may be implemented based on the ion trap system shown in any one of the embodiments in FIG. 2 to FIG. 15.

In the following description, an example in which a second light beam passes through a first relative delay module is used for description.

FIG. 16 is a schematic method flowchart of an ion manipulation method according to this application. The method includes the following steps.

Step 1601: A control module generates a first control signal based on a position of a first target ion.

For this process, refer to the description of controlling the first drive component by the control module in the foregoing case 1, and details are not described herein again.

Step 1602: The control module sends the first control signal to a first drive component. Correspondingly, the first drive component receives the first control signal from the control module.

The first control signal is used to control the first drive component to adjust a first relative delay module, to change an optical path of a second light beam. If an optical path adjustment component included in the first relative delay module is of the foregoing structure 1, the first control signal may control the first drive component to adjust a position of a galvanometer. For example, the first control signal may be used to control the first drive component to drive the galvanometer to a target position. If the optical path adjustment component included in the first relative delay module is of the foregoing structure 2, the first control signal may be used to control the first drive component to adjust a refractive index of an optoelectronic crystal. For example, the first control signal may be used to control the first drive component to adjust the refractive index of the optoelectronic crystal to a target refractive index. For details about the adjustment, refer to the description of the initialization process. Details are not described herein again.

Step 1603: The first drive component generates a first drive signal based on the first control signal, and sends the first drive signal to the first relative delay module.

The first drive signal is used to drive the first relative delay module. If the optical path adjustment component included in the first relative delay module is of the foregoing structure 1, the first drive signal is used to drive the galvanometer to move to the target position. If the optical path adjustment component included in the first relative delay module is of the foregoing structure 2, the first drive signal is used to drive the optoelectronic crystal to change the refractive index to the target refractive index.

Step 1604: The first relative delay module changes the optical path of the received second light beam based on the first drive signal.

In a possible implementation, if the optical path adjustment component included in the first relative delay module is of the foregoing structure 1, the galvanometer may move to the target position under an action of the first drive signal, to change the optical path of the second light beam. If the optical path adjustment component included in the first relative delay module is of the foregoing structure 2, the optoelectronic crystal may adjust the refractive index to the target refractive index under the action of the first drive signal, to change the optical path of the second light beam.

Based on the foregoing step 1601 to step 1604, at different moments, the optical path of the second light beam received by the first relative delay module may be controlled to be changed, so that a delay amount for the first light beam and the second light beam to reach an ion may be changed, so that the first light beam and the second light beam may overlap at different ions. For example, at a moment t_{A}, the first relative delay module may be controlled to move the galvanometer to a position A, so that the delay amount between the first light beam and the second light beam is ΔA, so that the first light beam and the second light beam overlap at an ion A. For another example, at a moment t_{B}, the first relative delay module may be controlled to move the galvanometer to a position B, so that the delay amount between the first light beam and the second light beam is ΔB, so that the first light beam and the second light beam overlap at an ion B.

Step 1605: The control module determines parameter information of a radio frequency source based on a quantum computing requirement, and generates a second control signal based on the parameter information of the radio frequency source.

The second control signal is used to control, by using a first radio frequency driver, a time sequence and/or a frequency of a first modulation component to modulate the first light beam, and control, by using a second radio frequency driver, a time sequence and/or a frequency of a second modulation component to modulate the second light beam.

Step 1606: The control module sends the second control signal to the radio frequency source. Correspondingly, the radio frequency source receives the second control signal from the control module.

Step 1607: The radio frequency source controls, based on the second control signal, the first radio frequency driver to drive the first modulation component, and controls the second radio frequency driver to drive the second modulation component.

Based on the foregoing steps 1605 to 1607, control of the timing and/or the frequency of the first light beam and/or the second light beam may be implemented, thereby implementing the required quantum computing.

It should be noted that, step 1601 to step 1604 may be understood as a process in which the control module controls the first relative delay module, and step 1605 to step 1607 may be understood as a process in which the control module controls the radio frequency source. The two processes are not performed in a sequence, or may be understood as that the two processes are performed simultaneously. The sequence of the steps provided above is merely for ease of description of the solution.

It should be noted that, in the foregoing embodiments, the control module may flexibly set specific time based on the quantum computing requirement for controlling the delay amount and each time domain (for example, a first time domain, a second time domain, and a third time domain).

The method steps in embodiments of this application may be implemented in a hardware manner, or may be implemented in a manner of executing software instructions by the processor. The software instructions may include a corresponding software module. The software module may be stored in a random access memory (RAM), a flash memory, a read-only memory (ROM), a programmable read-only memory (PROM), an erasable programmable read-only memory (EPROM), an electrically erasable programmable read-only memory (EEPROM), a register, a hard disk, a removable hard disk, a CD-ROM, or any other form of storage medium well-known in the art. For example, a storage medium is coupled to a processor, so that the processor can read information from the storage medium and write information into the storage medium. Certainly, the storage medium may be a component of the processor. The processor and the storage medium may be disposed in an ASIC. In addition, the ASIC may be located in an ion trap system. Certainly, the processor and the storage medium may also exist in the ion trap system as discrete components.

All or some of the foregoing embodiments may be implemented by using software, hardware, firmware, or any combination thereof. When software is used to implement the embodiments, all or a part of the embodiments may be implemented in a form of a computer program product. The computer program product includes one or more computer programs or instructions. When the computer program or the instructions are loaded and executed on a computer, all or some of procedures or functions in embodiments of this application are performed. The computer may be a general-purpose computer, a dedicated computer, a computer network, a network device, a user device, or another programmable apparatus. The computer program or the instructions may be stored in a computer-readable storage medium, or may be transmitted from a computer-readable storage medium to another computer-readable storage medium. For example, the computer program or the instructions may be transmitted from a website, computer, server, or data center to another website, computer, server, or data center in a wired or wireless manner. The computer-readable storage medium may be any usable medium accessible by the computer, or a data storage device, like a server or a data center, integrating one or more usable media. Alternatively, the usable medium may be an optical medium, for example, a digital video disc (DVD). Alternatively, the usable medium may be a semiconductor medium, for example, a solid-state drive (SSD).

In various embodiments of this application, unless otherwise stated or there is a logic conflict, terms and/or descriptions in different embodiments are consistent and may be mutually referenced, and technical features in different embodiments may be combined based on an internal logical relationship thereof, to form a new embodiment.

In this application, “perpendicular” does not mean absolute perpendicularity, and a specific engineering error may be allowed. “Multiple” refers to two or more than two. “And/or” describes an association relationship between associated objects, and represents that three relationships may exist. For example, A and/or B may represent the following cases: A exists alone, both A and B exist, and B exists alone, where A and B may be singular or plural. “At least one of the following items (pieces)” or a similar expression thereof refers to any combination of these items, including any combination of singular items (pieces) or plural items (pieces). For example, at least one of a, b, or c may indicate a, b, c, a and b, a and c, b and c, or a, b, and c, where a, b, and c may be singular or plural. In text descriptions of this application, the character “/” generally represents an “or” relationship between associated objects. In a formula of this application, the character “/” indicates a “division” relationship between associated objects. In addition, in this application, the term “for example” is used to represent giving an example, an illustration, or a description. Any embodiment or design scheme described as an “example” in this application should not be explained as being more preferred or having more advantages than another embodiment or design scheme. Alternatively, it may be understood as that the word “example” is used to present a concept in a specific manner, and does not constitute a limitation on this application.

It may be understood that, in this application, various numeric numbers are distinguished merely for ease of description and are not used to limit the scope of the embodiments of this application. The sequence numbers of the foregoing processes do not mean execution sequences, and the execution sequences of the processes should be determined based on functions and internal logic of the processes. The terms “first”, “second”, and the like are used to distinguish between similar objects without having to describe a specific order or sequence. In addition, the terms “include”, “have”, and any variant thereof are intended to cover non-exclusive inclusion. For example, a process, method, system, product, or device that includes a series of steps or units is not necessarily limited to those steps or units expressly listed, but may include other steps or units not expressly listed or inherent to such a process, method, system, product, or device.

Although this application is described with reference to specific features and embodiments thereof, it is clear that various modifications and combinations may be made to them without departing from the spirit and scope of this application. Correspondingly, this specification and the accompanying drawings are merely example descriptions of solutions defined by the appended claims, and are considered as any or all of modifications, variations, combinations, or equivalents that cover the scope of this application.

Clearly, a person skilled in the art can make various modifications and variations to this application without departing from the spirit and scope of the present invention. In this way, this application is intended to cover these modifications and variations of embodiments of this application provided that they fall within the scope of protection defined by the following claims of this application and their equivalent technologies.

What is claimed is:

1. A particle trap system, comprising:
a particle trap configured to trap at least two particles;
a first optical splitter configured to split an input light beam into a first light beam and a second light beam; and
a first optical delay configured to adjust a delay for the first light beam and the second light beam to reach a first target particle,
wherein an adjusted first light beam and an adjusted second light beam overlap at the first target particle, and
wherein the first target particle one of the at least two particles.

2. The system according to claim 1, wherein the particle trap system further comprises a light source configured to transmit the input light beam based on a first pulse width, wherein a first space distance corresponding to the first pulse width is less than a spacing between any two adjacent particles of the at least two particles in the particle trap.

3. The system according to claim 2, wherein a second space distance corresponding to a time interval at which two adjacent light beams are sent is greater than a spacing between any two of the at least two particles in the particle trap.

4. The system according to claim 1, wherein the first optical delay is configured to change an optical path of the first light beam and/or an optical path of the second light beam.

5. The system according to claim 1, wherein the first optical delay comprises:
a first drive component configured to send a first drive signal to an optical path adjustment component based on a first control signal, the first control signal being determined based on a position of the first target particle; and
the optical path adjustment component, which is configured to change, based on the first drive signal, an optical path of the first light beam and/or an optical path of the second light beam.

6. The system according to claim 5, wherein the optical path adjustment component comprises:
a galvanometer configured to:
change the optical path of the first light beam and/or the optical path of the second light beam based on the first drive signal, and
propagate the first light beam and/or the second light beam to a reflector; and
the reflector, which is configured to reflect, to the first target particle, the first light beam and/or the second light beam.

7. The system according to claim 2, wherein the particle trap system further comprises a first optical branch and a second optical branch;
the first optical branch being configured to propagate, to the first target particle, the first light beam; and
the second optical branch being configured to propagate, to the first target particle, the second light beam.

8. The system according to claim 7, wherein the first optical branch comprises a first optical modulator configured to modulate a time sequence and/or a frequency of the first light beam; and/or
the second optical branch comprises a second optical modulator configured to modulate a time sequence and/or a frequency of the second light beam.

9. The system according to claim 8, wherein the first optical branch further comprises a first polarizer, and the second optical branch further comprises a second polarizer; and
the first polarizer is configured to convert a polarization state of the first light beam into left hand circularly polarized light and the second polarizer is configured to convert a polarization state of the second light beam into right hand circularly polarized light; or
the first polarizer is configured to convert a polarization state of the first light beam into right hand circularly polarized light and the second polarizer is configured to convert a polarization state of the second light beam into left hand circularly polarized light.

10. The system according to claim 1, further comprising:
a second optical splitter configured to split the second light beam into N third light beams, N being an integer greater than 1,
wherein the first optical delay comprises N relative delay submodules,
wherein each respective third light beam of the N third light beams corresponds to a respective relative delay submodule of the N relative delay submodules, and
wherein each respective relative delay submodule is configured to change a delay amount for the first light beam and the respective third light beam to which it corresponds to reach the first target particle.

11. The system according to claim 1, further comprising:
a first light beam recovery configured to propagate a fourth light beam to a second relative delay module, the fourth light beam being formed from remaining light of the first light beam after the first target particle is manipulated or remaining light of the second light beam after the first target particle is manipulated; and
the second optical delay, which is configured to adjust a delay amount for the fourth light beam and the first light beam to reach a second target particle,
wherein an adjusted fourth light beam and an adjusted first light beam overlap at the second target particle,
wherein the second target particle is a particle of the at least two particles other than the first target particle, and
wherein an optical path of the fourth light beam is equal to a sum of k times the second space distance and two times a spacing between the first target particle and the second target particle, k being a positive integer.

12. The system according to claim 11, further comprising a first optical filter configured to transmit the fourth light beam from the first light beam recovery and propagate the fourth light beam to the second optical delay.

13. The system according to claim 11, wherein the second optical delay is configured to change an optical path of the fourth light beam, and propagate, to a second optical branch, the fourth light beam whose optical path is changed; and
the second optical branch is configured to propagate, to the second target particle, the fourth light beam whose optical path is changed.

14. The system according to claim 2, wherein the light source comprises a femtosecond pulse laser.
